(19) United States
(12) Patent Application Publication
(10) Pub. No.: US 2022/0213675 A1
(43) Pub. Date: Jul. 7, 2022

(54) TOILET DEVICE WITH ENHANCED CONTROL AND SUPPORT FUNCTIONS

(71) Applicants: Karl-Josef Kramer, Livermore, CA (US); Werner Kramer, Bad Breisig (DE)

(72) Inventors: Karl-Josef Kramer, Livermore, CA (US); Werner Kramer, Bad Breisig (DE)

(21) Appl. No.: 17/608,977

(22) PCT Filed: May 14, 2020
(86) PCT No.: PCT/US20/32966

§ 371 Date: Nov. 4, 2021

Related U.S. Application Data
(60) Provisional application No. 62/847,906, filed on May 14, 2019.

(51) Int. Cl. E03D 9/08; A47K 10/48; H04N 5/225; H04N 7/18

(52) U.S. Cl. CPC E03D 9/08; A47K 10/48; H04N 7/183; H04N 5/2256; H04N 5/2257

(57) ABSTRACT

A toilet device with inspection functions, highly controllable cleaning, drying, visual observation and reporting functions. Certain embodiments of such observation, inspection, cleaning and drying of the user's posterior and genitals are introduced in some detail, and so are the automatic self-cleaning and drying mechanisms, structures and methods of the observation and cleaning devices. This device allows the user to take full control of observing their bowel movement as well as controlling proper cleaning and drying afterwards. In addition, toilet device embodiments are presented which can be combined with the described observation and cleaning features and which support people lacking mobility, strength or coordination or having sensory impairments by executing certain bodily motions, such as bringing the user into a more or less crouching or rocking position in order to facilitate bowel movement. For all actuations, activation via voice, push button, touch screen or joystick control are all envisioned.

### CROSS-REFERENCE TO RELATED APPLICATIONS

This application claims priority to U.S. Provisional Application Ser. No. 62/847,906, filed May 14, 2019, which is hereby incorporated by reference in its entirety.

### FIELD

The present technology relates to toilet devices with integrated functions for cleaning, drying, inspection, treatment and support functions.

### BACKGROUND

The field of toilets with bidets is growing and the acceptance of such toilets is spreading from Asian markets where the devices were first widely accepted to other markets.

Such bidet toilets typically include at least one port for rinse water to replace or support the traditional use of toilet paper with the use of a cleansing water jet. Additional amenities such as air drying, seat heating and various pulsation and strength adjustment of the water jet are readily available.

Bidet toilets on the market to date carry out the water cleansing task essentially blindly in that they give the user no means to visually directly inspect the cleansing process.

In addition, there is no integrated capability of visually inspecting and documenting the user's behind or genitals, especially for female users. Also, while some toilets allow the reporting of stool consistency, there is no toilet on the market that allows the user to observe and visually document their stool.

Handicapped or mobility impaired people, as well as visually impaired people benefit from a high degree of automation, as well as, if residual vision is still available, from visual enhancement techniques through the disclosed features.

### SUMMARY

This disclosure presents a device and technology which seeks to overcome one or more of the limitations seen in bidet toilet devices on the market today. We are presenting means for strongly enhanced control, visibility and reliable, documentable cleansing, as well as means for early detection of a large variety of health or diet related issues that the user may have.

We present easy and readily usable means for the user to document and relay their information for their own safekeeping, but also to caregivers and medical staff. All this is possible confidently and in a confidential way.

For mobility limited people we present additional means to enhance their capability and control of cleansing, but also provide novel apparatuses to support the bowl movement process particularly for such users.

Particularly people with limited mobility often cannot see and inspect their excretions or cannot sense the completion of the excretion process. But also, in general, toilet users are typically not able to see their posteriors after excretion and cleaning.

This disclosure teaches several embodiments of applying observation cameras, fixed or mobile, into the toilet bowl and keeping them operational.

Very importantly, it is also demonstrated how such devices are kept clean during daily use by employing certain useful structures and methods.

It also teaches the application of such observation cameras in directly controlling and improving the cleansing process after excretion by various techniques.

In addition, we disclose cleansing component concepts for superior control and results of cleaning.

It also teaches the use of either voice control, touch screen control, joystick control or a combination thereof for applying bidet functions of rinsing and drying and moving cameras to cover the entire region of interest.

In addition, it teaches the use of image recognition for determining that the user's posterior is sufficiently undressed during the session.

For paraplegic and quadriplegic users, it is also essential to directly observe completion of the excretion process, as well as to observe cleaning and drying, as such users often have little or no sensation in addition to their lack of mobility to observe these critical points. Being able to have excellent control over each status is self-evident for many. Yet it can make a significant contribution to self-confidence and overall quality of life to those with said restrictions or handicaps.

The features provided in this disclosure are also amenable and very useful to users without mobility impairment, especially as it concerns the capability to document stool and users' posteriors.

Furthermore, this disclosure features apparatuses and methods for enhanced drying after the water cleaning. Such enhanced and accelerated, hygienic drying is an essential feature for those with reduced mobility, strength or sensory ability

### BRIEF DESCRIPTION OF THE DRAWINGS

The features, nature, and advantages of the disclosed subject matter may become more apparent from the detailed description set forth below when taken in conjunction with the drawings in which like reference numerals indicate like features and wherein:

FIG. 1 depicts a toilet device with bidet function by water jet and camera function. Said camera and bidet functions residing in a resting area below the rear of the toilet seat. The figure depicts the mechanism in idle state, with both water jet cleaning mechanism and observation mechanism retracted.

FIG. 2 depicts a toilet device with bidet function by water jet and camera function. Said camera and bidet functions residing in a resting area below the rear of the toilet seat. The figure depicts the mechanism in an operational state, with both water jet cleaning mechanism and observation mechanism moved out and engaged. A front camera is engaged in observing the cleaning process.

FIG. 3 depicts a toilet device with bidet function by water jet and camera function. Said camera and bidet functions residing in a resting area below the rear of the toilet seat. The figure depicts the mechanism in an operational state, with the water jet cleaning mechanism in idle but the observation mechanism moved out and engaged.

In this embodiment, three cameras are employed, one to look forward for examining the excretion or subsequent cleaning process from a safe distance, the other looking upward to observe and inspect the user's buttocks and genitals when engaged and a third camera looking downward to observe and inspect the excrements.

FIG. 4A shows a view of a ring illumination, seen from below the seat. A ring of LEDs is arranged around the circumference of the seat, preferably smoothly integrated into the surface for easy maintenance.

FIG. 4B shows a cross section of the toilet bowl, illustrating illumination light from various LED sources being reflected and scattered along various paths.

FIG. 5A shows a side view of the assembly for the observation cameras, mounted in a telescopic fashion. Said cameras protected by a preferably clear, preferably smooth-surfaced preferably cylindrical and easily exchangeable cap.

FIG. 5B shows a top view of the assembly for the observation cameras, mounted in a telescopic fashion. Said cameras protected by a preferably clear, preferably round and smooth surfaced preferably cylindrical and easily exchangeable cap. A separation line indicating the segmentation of the front camera mount is shown.

FIG. 6 shows a side view of the assembly for the observation cameras, mounted in a telescopic fashion. Said cameras protected by a preferably clear, preferably smooth-surfaced preferably cylindrical and easily exchangeable cap. An infrared or thermal camera is operated in parallel to a visible light camera.

FIG. 7 depicts exemplary images comparing side by side visible and thermal or infrared images, as well as same visible and thermal images at a different point in time for the same user.

FIG. 8 shows a view of the camera device housing and camera mount body, taken from another angle, such as to show an exemplary drive mechanism for the telescopic camera mount body. Also indicated are cleaning and drying ports.

FIG. 9 shows a view of the camera device housing and camera mount body, mounted in a telescopic fashion, with internal details highlighted which depict rinse water and drying air supply lines leading to a ring of rinse nozzles and a ring of drying nozzles near the front of the camera device housing.

FIG. 10 shows the same assembly for the observation cameras, mounted in a telescopic fashion, at a side view perspective, with internal details depicting rinse water and drying air supply lines leading to a ring of rinse nozzles and a ring of drying nozzles near the front of the camera telescope mechanism housing.

FIG. 11 shows a top view of the assembly for the observation cameras, mounted in a telescopic fashion, taken from another angle, such as to show an exemplary drive mechanism of the telescopic rod. Also indicated are cleaning and drying lines and ports. The two extreme positions of fully retracted (FIG. 11A) and fully extracted (FIG. 11B) telescopic rod are depicted.

FIG. 12 shows a side view of the assembly for the observation cameras, mounted in a telescopic fashion, with emphasis on the cables of the camera leading from camera controller to image sensor. This embodiment depicts a mobile camera, with moving image sensor cable, and a stationary camera controller with antenna.

FIG. 13 shows a side view of the assembly for the observation cameras, mounted in a telescopic fashion, with emphasis on the cables of the camera leading from camera controller to image sensor. This embodiment depicts a mobile camera, with moving camera controller with antenna. In this embodiment the power supply cable to the camera controller and antenna is moving when the camera assembly is moved.

FIG. 14A shows a toilet device with a cleaning and observation mechanism with a user and with a monitor that lets the user observe their buttocks or genital region and lets the user directly control the cleaning of said region, in this picture by means of a crosshair indicating the expected hit region for the cleansing water jet.

FIG. 14B shows a close-up of a monitor showing images of a toilet user's buttocks or genitalia, with indication of control for the user as to where the water jet will hit, as well as camera control to center the camera image in the most important regions; said control optionally via a joystick, touchscreen or voice activated.

FIG. 15A depicts a bidet tube, containing a cleaning fluid or water tube and nozzle, as well as a laser or point light source arranged such as to shine light concentrically and in the same direction as a cleaning fluid or water jet emanating from said cleaning fluid nozzle.

FIG. 15B depicts a bidet tube, containing a cleaning fluid or water tube and nozzle, as well as a laser or point light source arranged to shine light in parallel and close proximity to a cleaning fluid or water jet emanating from said cleaning fluid nozzle.

FIG. 16 depicts a toilet device with a user, said toilet device having a movable, rockable seat and backrest assembly, with the seat and backrest assembly in idle state.

FIG. 17 depicts a toilet device with a user, said toilet device having a movable, rockable seat and backrest assembly, with the seat and backrest assembly in engaged and tilted state, exposing a gap between seat and toilet bowl which is covered by a flexible or movable skirt or other means.

FIG. 18 depicts a toilet device with a seat, said seat containing an actuation mechanism to separate the seat at the rear part, for instance by a worm gear driven assembly or similar. Said seat also contains anchor or pivot points further forward around which the two seat halves pivot upon actuation. Said depicted seat also contains an upper and a lower segment where the actuation is effected onto the upper segment.

FIG. 19A depicts a toilet device with a seat, said seat containing actuation mechanisms wherein one mechanism acts to separate the seat at the rear part, for instance by a worm gear driven assembly or similar. Said seat also contains an actuation mechanism to lift the thighs of the user up.

FIG. 19B depicts the same toilet device as FIG. 19A, but with inner and outer sealing skirt also shown.

FIG. 20 depicts a cross section of a toilet device with a seat, taken across the toilet bowl, wherein said seat contains an upper and a lower segment and wherein said lower segment is partially enclosed or hidden inside the bowl and wherein various actuation mechanisms and rinsing mechanisms are included.

FIG. 21 depicts a toilet seat, seen from below, with an arrangement for drying the user's posterior.

FIG. 22 shows a side view of a toilet seat with a user and an arrangement of a drying mechanism for the user's posterior.

FIG. 23 shows an air curtain with additional air extraction along the rear end of a toilet seat.

### DETAILED DESCRIPTION

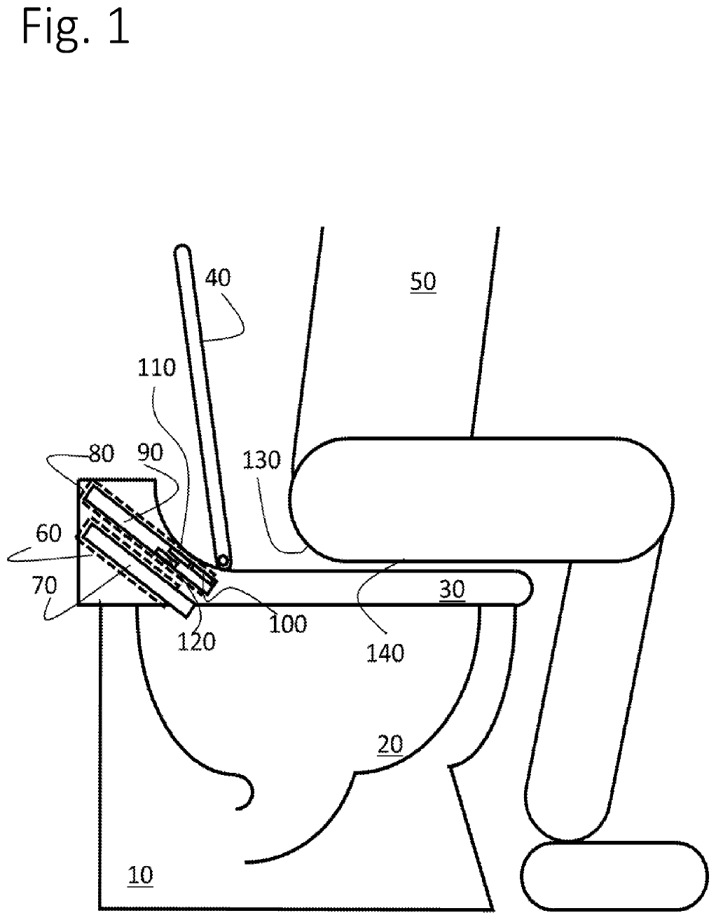

FIG. 1 depicts a toilet device 10 with toilet bowl 20 and toilet seat 30, toilet lid 40 in open position, a toilet user 50, an integrated bidet function with a telescopic actuation mechanism 60 with a bidet tube in retracted position 70, as well as a camera observation device, with a housing, drive and telescopic actuation mechanism 80 to drive a camera mount body 90, containing one or more cameras 100, 110, 120 for various observations to be explained below. In the depicted status, both the bidet function 70 and the camera observation function with the camera mount body 90 are fully retracted and in idle mode. Also depicted is a user's buttock or posterior region 130 as well as frontal genital region 140.

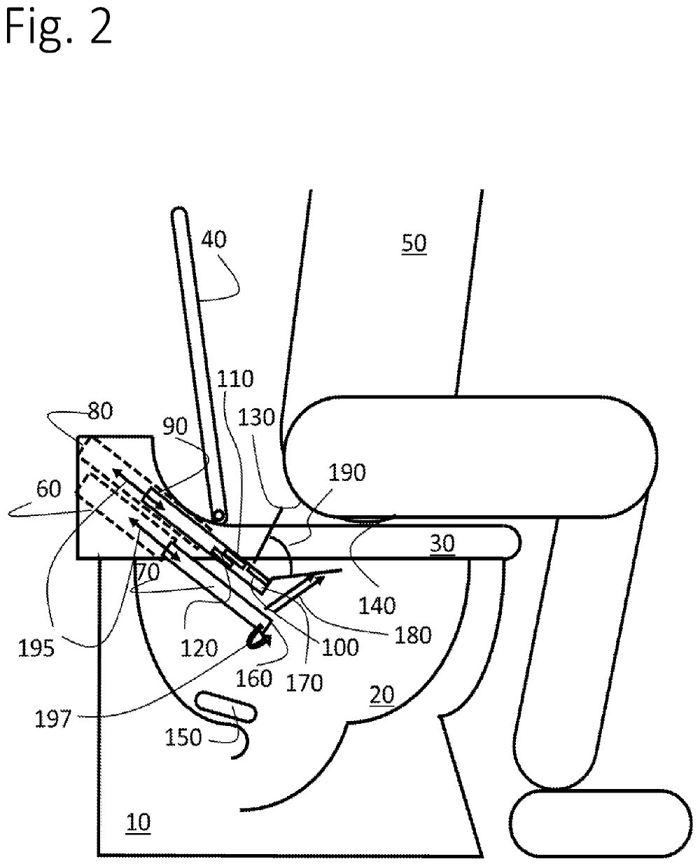

FIG. 2 depicts a toilet device 10 with toilet bowl 20 and toilet seat 30, a toilet user 50, an integrated bidet function with a telescopic actuation mechanism 60, as well as a camera observation device, with a telescopic actuation mechanism 80, containing one or more cameras 100, 110, 120 for various observations to be explained below. An excrement 150 is also shown. In the depicted status, both the bidet function 60 with bidet tube 70 and the camera observation function 80 with the camera mount body 90 are in their active and engaged positions 160 and 170, respectively. The bidet's telescopic arm is bringing a cleaning fluid jet 180, most readily water, which may be heated, pulsed, activated using air, CO2 or other gas bubbles, or ultrasonic energy, can be oscillated by moving backward and forward, or by moving sideways or rotated around an axis, and regulated in strength to the user's buttocks or genital region in order to effect cleansing of these regions. Instead of water, a cleaning solution such as soapy water can also be implemented, as well as a combination, starting out with soapy water and finishing with plain water can be implemented. In addition to cleansing, the cleaning fluid jet 180 can also be focused on the user's anal region to serve as an enema to induce excretion.

A frontal viewing camera 100 with a wide-angle viewing field 190 can observe the cleaning process or the enema inducing process from a relatively protected position.

The depicted bidet function in its standard embodiment has one direction of motion, typically inward and outward of the bowl 195, with a fixed or extension-dependent angle. However, in a further embodiment said bidet function contains an additional actuation, such as a rotary motion 197 around its long axis. With that in place, the fluid jet can be applied by coupled motions, such as circular or ellipsoidal motion of the water jet.

The depicted camera observation mechanism is actuated in this figure in such a way that the camera is located in a safe position near the rear of the bowl, such as to not interfere with the cleansing process. As the camera observation mechanism is actuated, the covering door, described later in this disclosure, is opened.

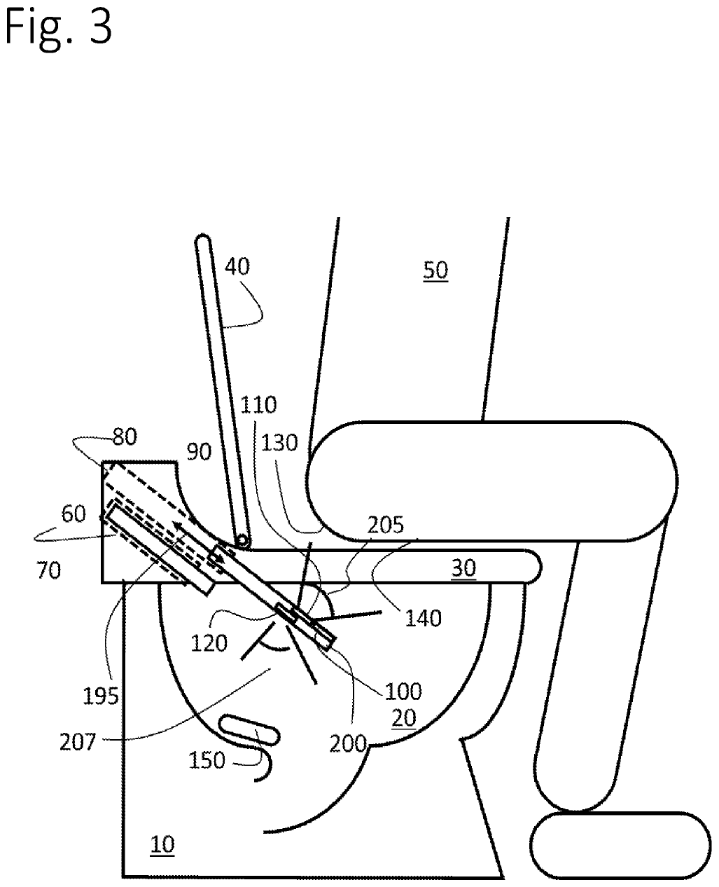

FIG. 3 depicts a toilet device 10 with toilet bowl 20 and toilet seat 30, a toilet user 50, an integrated bidet function 60 with a telescopic actuation mechanism, as well as a camera observation device 80, with a telescopic actuation mechanism, containing one or more cameras 100, 110, 120 for various observations to be explained below. In the depicted status, the bidet function 60 with bidet tube 70 is retracted and idle, but the camera observation function 80 with camera mount body 90 is active and engaged in an extended position 200. In this position 200, the top camera 110 with large viewing angle 205 allows observing the user's buttocks 130 or front genital region 140. A camera with a sufficiently wide angle, with adequate distance from the body parts to obtain a sufficiently focused image, may allow the user to observe both buttocks and genital region at the same time. Otherwise the user may control the camera location, for instance using a remote control, a touchscreen, a touchscreen of a smart phone or tablet, a joystick or via voice control.

A downward oriented camera 120 with viewing angle 207 can also visualize and optionally record the user's excrements 150.

Camera observation of the user's buttocks or genitals greatly enhances the control over the degree of cleanliness after the post-excretion cleaning process. It also allows the user observation and early detection of a multitude of issues in the region, for instance, but not limited to the onset of menstruation for female users, infections such as yeast infections, but also hemorrhoids, abscesses, bowel inversion issues (often encountered with paraplegics), decubitus, fungal growth issues and many more. Regular observation of this region trains the user's eye on any changes occurring that warrant an action. With the observation cameras linked to controllers, such as smart phones or tablets via cable, WiFi, Bluetooth or other preferably but not exclusively wireless data transfer, images of the region can be viewed as live images, can be stored as well as forwarded to care givers or medical staff for further analysis, where and when warranted.

Image acquisition, processing, storage and transfer can readily be done in a safe mode, by using user detection, encryption and other safety precautions. Different users may each use their own device for control by downloading the control app provided by the toilet supplier.

By storing images and using advanced image analysis such as employing learning and artificial intelligence in general, a system can be devised which, for one, can track any medically relevant changes in the captured images over time and trigger alerts for further examination. By using anonymous user data base information from preferably a large set of volunteer users, we also conceive that the system will be capable to identify symptoms and observations made by images from an individual user, including development of such images over even long time scales, and comparing medically significant features with identified medical symptoms and observations from said data base or bases.

The same telescopic arm can contain several cameras 100, 110, 120. In addition to observing the excretion and cleansing process 100, we have described a camera to observe the user's buttocks and genitals 110. That is done by an upward looking camera. It is also possible to have a camera looking downward into the bowl 120, in order to observe and optionally store images of the user's excretions. Alternatively, the upward camera can be rotated downwards to also inspect and store images of excrements. Having separate cameras has the advantage of certain simplifications in terms of being able to instantly switch from image to image on a display screen (such as above-mentioned screen of smart phone or tablet).

The employed cameras may benefit from autofocus. Alternatively, lenses that show focused images in the range of interest are also suitable. For illumination, several scenarios are available, including at least one light, preferably a light emitting diode. For ideal and low shadow illumination, this disclosure teaches two different embodiments, wherein one comprises a ring of LEDs, which can for instance be mounted on the bottom side of the toilet seat, preferably integrated flush with the lower surface of the seat. For good camera image color fidelity, it is advisable to use LEDs, or illumination in general that is not red-deficient. Illumination with distinct colors or wavelength, however, can help in the determination of certain physical issues the user may exhibit in the buttocks or genital region.

It should be noted that while embodiments presented in this disclosure contain a plurality of cameras for observing cleaning process, user's posterior and genitals as well as excrements, it is also conceived to cover all these observation tasks with a single camera, for instance by using additional rotation or mirror functions to capture the respective regions of interest. However, we believe that the overall system benefits significantly from the use of a plurality of cameras for speed and simplicity, as images can be taken essentially simultaneous and split screen live imaging is also possible.

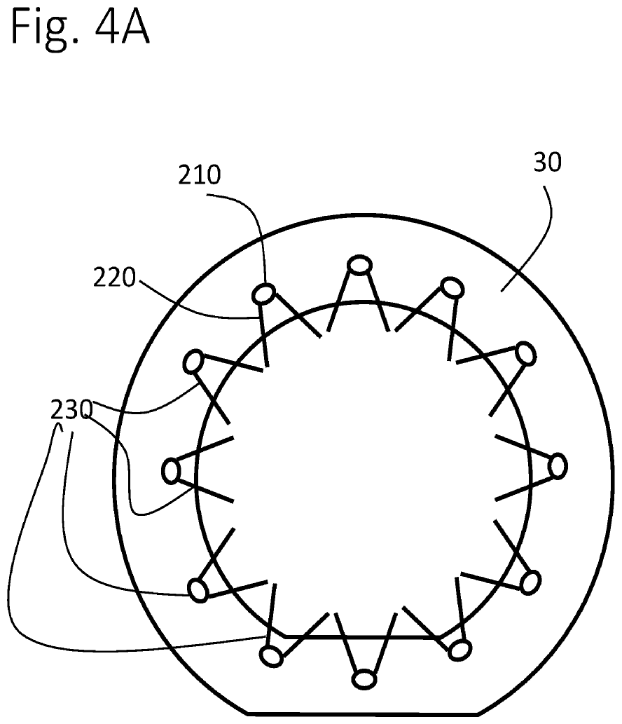

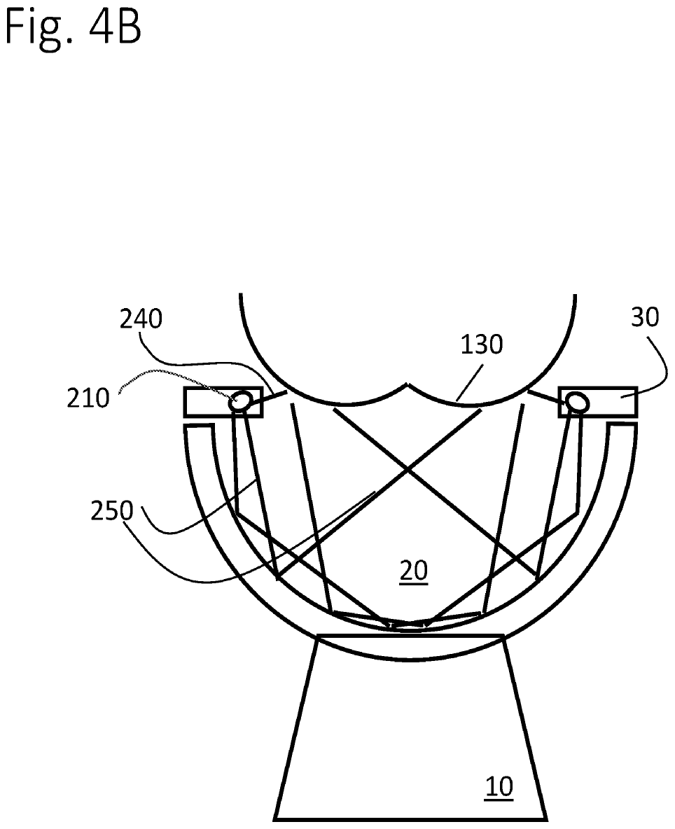

FIG. 4A shows a view of a ring illumination, seen from below the toilet seat 30. LEDs 210 with emission angles 220 are arranged in a ring 230 around the circumference of the seat, preferably smoothly integrated into the surface for easy maintenance. Co-molding of viewports for the LEDs with the toilet seat or manufacturing the toilet seat 30 at least partially from a transparent material, are both options to accomplish clean and smooth integration of such ring illumination.

FIG. 4B shows a cross section of the toilet device 10 with toilet bowl 20, toilet seat 30 and toilet user's buttock region 130, illustrating illumination light rays from various LED sources 210 being either aimed directly 240 or reflected and scattered 250 along various paths, essentially eliminating any shading and assuring even illumination of the user's posterior for imaging purposes. The toilet bowl itself is typically manufactured from a white material (ceramic or plastic) and also supports the even illumination through its diffuse reflection characteristics.

Another option for illumination is to have the illumination as part of the camera telescope, or to have a separate motorized illumination, akin to the motorized camera illumination, but either coupled, monolithic or separate, in order to optimize cost or performance of such an alternative illumination concept.

The camera observation mechanism benefits from automatic cleaning and drying, even as a precautionary measure. Such automatic cleaning and drying of the camera observation mechanism can make use of the telescopic motion mechanism, by engaging a camera telescope cleaning and drying arrangement which will be described further in this disclosure.

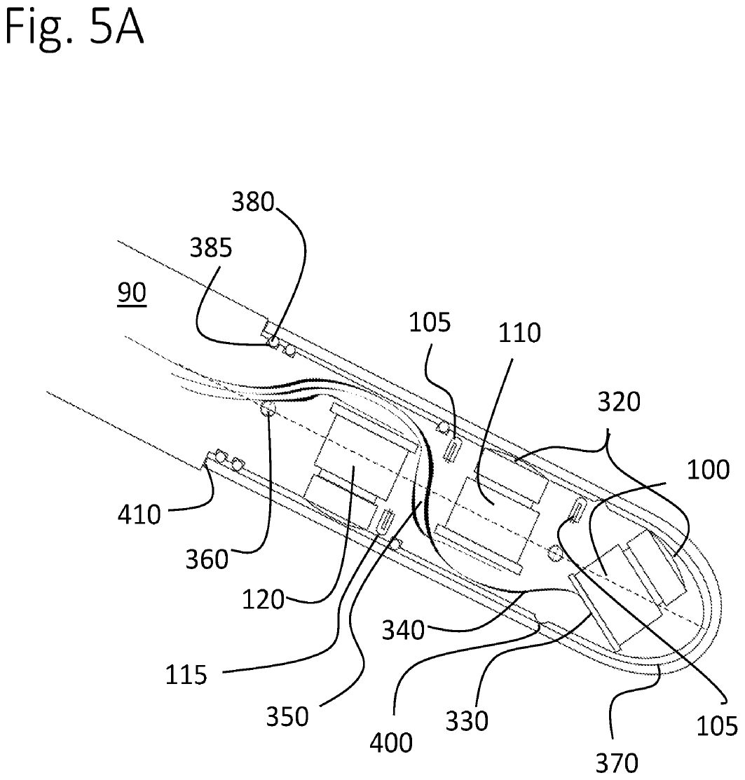

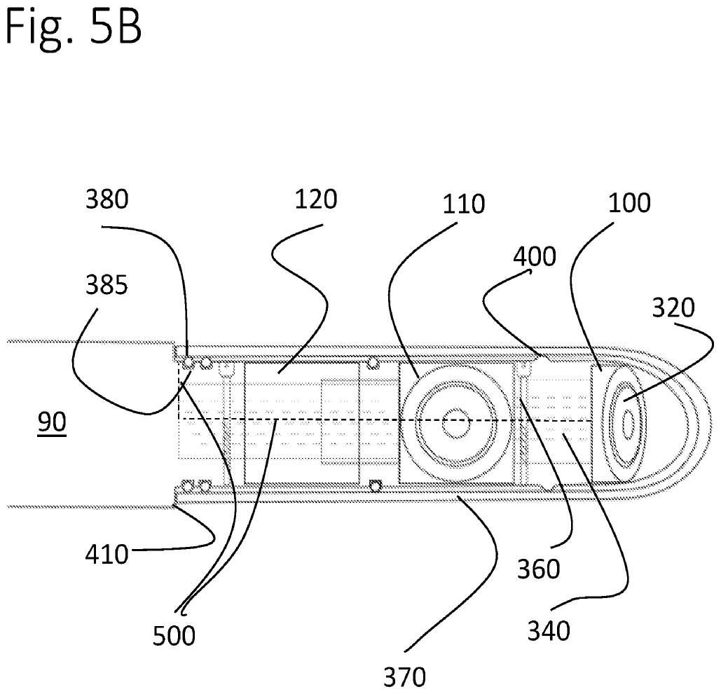

FIG. 5A depicts a sample structure of the driven telescopic arm structure that contains the cameras. In this embodiment, three cameras 100, 110, 120 are mounted onto a telescope camera mount body 90. It also depicts one or more upward illuminating topside light emitting diodes (LEDs) 105, as well as one or more downward oriented bottom side illuminating LEDs 115.

A first, frontal camera 100 is angled to readily depict the excretion and the cleansing process while only being extracted a minimal distance. Alternatively, and not shown here, such a camera can be mounted fix inside the bowl or inside the bowl walls, best covered and protected by a transparent window that is arranged flush with the toilet bowl.

Said camera consists of a base with the image sensor 330, and a lens arrangement with the wide-angle lens 320 with cover at the top.

Also shown is the camera cable 340 that is being routed towards the back.

Another camera 110 is position for upward views, such as to observe and inspect the user's buttock or genitals, depending on the position of the telescope. The same features of image sensor base, wide angle lens and cables are shown.

Thirdly, a downward angled camera 120 is implemented which can inspect the lower portion of the toilet bowl, notably the user's excrements. The camera cables are routed through a non-interfering path 350 such that standard flat cable can be employed, even though round cable bundles are also an option.

The displayed embodiment teaches one means of having mobile cameras, of protecting the cameras from soiling, of rendering the camera mount body easily cleanable, of covering all viewing areas of interest and of enabling quick camera exchange. Other means can be derived from this embodiment, using similar performance criteria.

Said top side (105) and bottom side (115) LEDs may provide one or more benefits or functionalities. Having the illumination source for a camera close to, but not directly scattering into the camera, provides light paths without shading, as light from the LED may hit all the surfaces visible and exposed to its adjacent camera. In addition, image recognition as well as diagnostics may benefit from illuminating a user's buttocks or genitals by selectable color or wavelength LEDs such as to highlight certain features and distinguish certain observed potential health issues and thus help in diagnosis.

The cameras are protected from the environment by a transparent cover 370 with a preferably but not necessarily cylindrical shape, with flat or rounded front surface. Said cover should at least be transparent in the camera regions. This at least locally transparent cover is connected to the telescope camera mount body. The connection in this embodiment is realized by at least one, preferably a plurality of O-Rings 380 located behind the camera region. Said O-Rings, sitting in O-Ring grooves 385, in the camera mount body, together with optional distancing guidance spacers 400 along the edges of the front part of the telescope camera mount body, also serve to easily align the transparent cover to the telescope camera mount body. The transparent cover is preferably easily removable for cleaning or for access to the cameras if required.

The ledge 410 of the camera mount body behind the transparent covers should have a diameter or extent barely but sufficiently larger than the outer diameter or extent of the transparent cover, such as to prevent the cover from being stripped off accidentally upon retraction of the telescope mechanism.

Also shown in this image are optional screws 360 to hold together two segments of mounting blocks for the camera mount. Alternatively, such mounting can be done without using screws, but rather by snapping two pieces together.

Ideally, the telescope camera mount body is made from an injection molded plastic with an easily cleanable surface. Optionally such surface can be coated with a coating that is antimicrobial and rejects dirt.

The transparent cover is preferably in a round or ellipsoidal cross-sectional shape, as this readily enables rinse water to be removed either by dying or by gravity roll-off and reduce issues of drying on and leaving calcification stains after a while. If not round or ellipsoidal, it should at least be smooth, such as to readily enable cleaning and drying. Tilting the camera mount body 90 downwards into the toilet also facilitates readily shedding of cleansing liquid. It also enables efficient drying.

For calcification stains, however, it is envisioned that the transparent cover can easily be removed by the user or directly be cleaned by a suitable, e.g. vinegar containing cleaner. The user engages a software function that moves the telescope arm out for maintenance, and then pulls the transparent cover off from the O-Rings. It should be noted that to prevent or alleviate calcification, it is also envisioned to add a decalcification agent to the cleansing liquid.

FIG. 5B shows a top view of the telescopic camera mount body 90. Segmentation lines or seams 500 are shown (dashed) which indicate an example how the mount body can be segmented into two portions for easy mounting and replacement of the cameras. Threaded screws 360 as example of a fastening mechanism are also depicted.

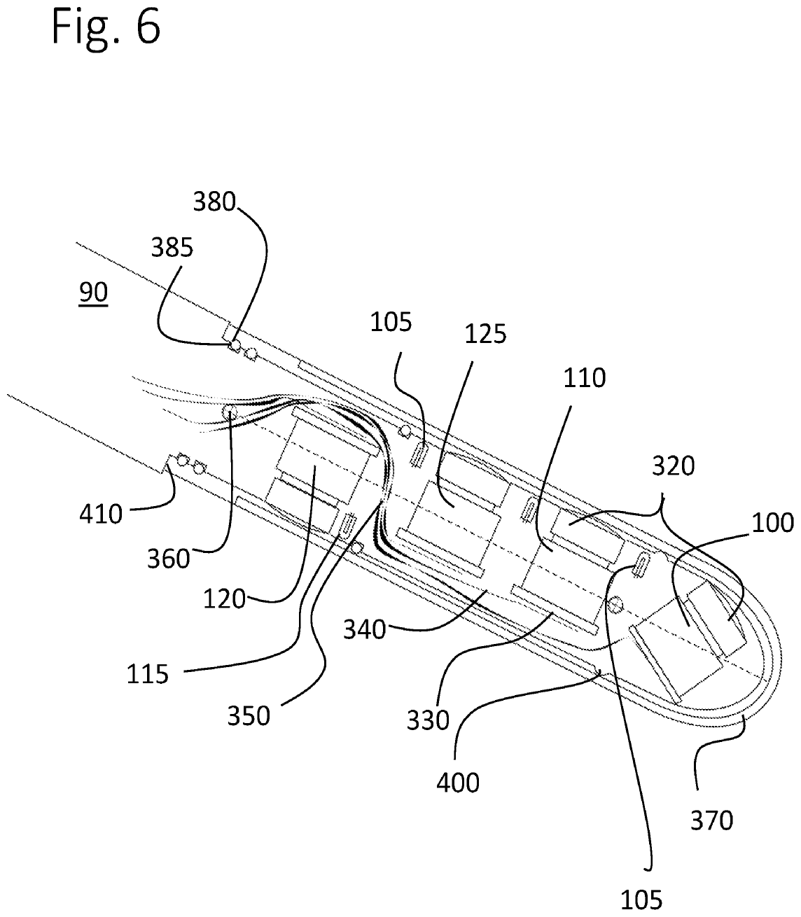

FIG. 6 shows a sample embodiment of a camera mount body 90 which contains, in addition to the embodiment presented in previous figures an additional arrangement. A thermal or infrared camera 125 is arranged to capture an image common with top camera 110. Here, the terms thermal and infrared cameras may be used interchangeably, but with the intention to state that cameras in the near infrared as well as in the far, longer wavelength, infrared, are conceived as part of this embodiment. Specifically, low cost infrared cameras can be made either of silicon cameras with a filter preventing visible light to hit the sensor. An alternative material that captures infrared information further into the infrared (often sensitive up to about 1700 nm wavelength) are InGaAs (Indium gallium arsenide) cameras, which are becoming more affordable, particularly when resolution lower than high definition (HD) is required. In the presented arrangement, both cameras are arranged adjacent to each other. A benefit for the user and for diagnostic purposes is that a thermal or infrared image of a same region of the body that is captured by a camera working with visible light may reveal additional features and may help in distinction and diagnosis of certain health related issues. Localized inflammations, particularly when confined under the skin, may for instance not be distinguishable in the visible image, but may show a signature in relationship to adjacent points on a user's skin surface. Even visible surface inflammations may only manifest themselves as such when observed using thermal imaging. Contrary to inflammations which typically may have a signature of locally increased temperature, regions of insufficient blood circulation may show up as having a cooler thermal signature.

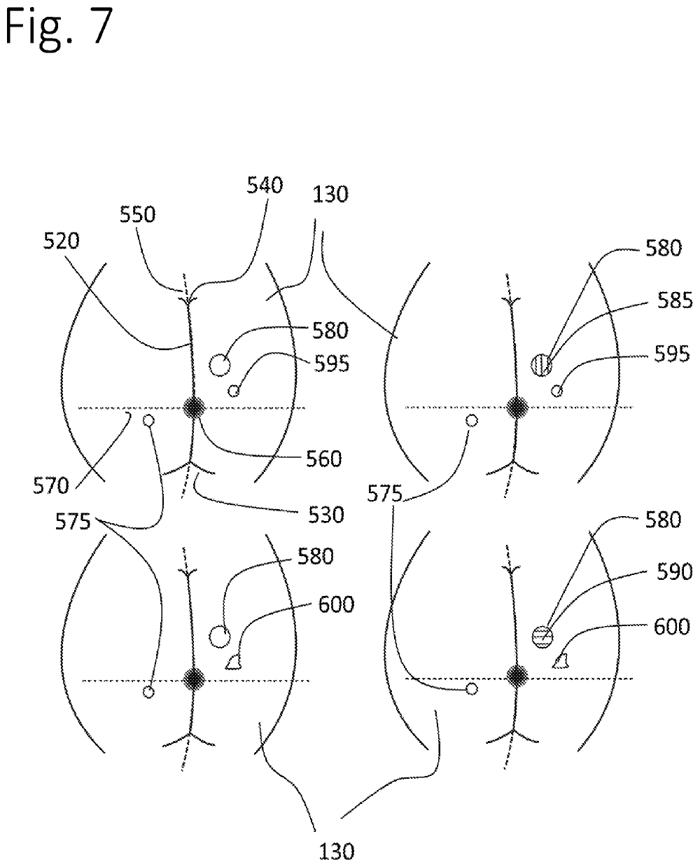

FIG. 7 gives exemplary visualization of images of a user's buttock. The figure conveys separate phenomena. For once, it demonstrates how capturing images over the course of time can be tracked and compared. In addition, it conveys how with the help of infrared or thermal imaging and by comparing such images with images captured using visible light as illumination spectrum, certain health-related features may be addressed and identified.

In FIG. 7, the upper two figures signify images of a user's posterior region 130, wherein the left figure refers to a visible light image and the right figure signifies an infrared or thermal image of the same region.

The lower two figures signify the same set of images, taken at a different point in time, with the intent of examining differences.

In all four images, a user's posterior region 130 is imaged. Marked here in an exemplary way are three observed anomalies. Anomaly 570 consisting of an observed visual anomaly without a thermal signature, which remains unchanged over the time period of observation. Anomaly 580 is a visible anomaly with a thermal signature indicated by horizontal hash marks 585, wherein same thermal signature changed over time, indicated by vertical hashmarks 590. In this specific example, the visible geometric extent 580 remains unchanged over time.

Anomaly 595 indicates an example of an anomaly without a thermal signature, but with an evolved size or shape, indicated by the changed anomaly outline 600.

Coordination of thermal images with visible images, as well as coordination of observed features from one occasion to the next at a different point in time can be aided by certain orientation aides along the user's anatomy. For instance, local image contrast from the user's intergluteal cleft 520 can serve as a quasi-vertical orientation help, whereas a user's anus 560 can serve as the origin of a quasi-horizontal orientation line 570. It is to be noted that both the quasi-horizontal and the quasi-vertical line are in general not exactly horizontal or vertical, but are envisioned to nevertheless be used as references for the image processing and assigning specific visible anomalies to their thermal or infrared counterparts, as well as assigning specific anomalies taken at one time to same anomalies taken at a different point in time. The software may set certain reasonable threshold for changed geometries or thermal signatures as warnings or alerts to a user. Additional anatomic features may also serve for improved orientation and geometrical assignments. For instance, the gluteal fold 530, genital location or the tip of the intergluteal crest 540 may also serve as orientation supports. Additionally, any anomalies as well as specific individual users' features themselves may be utilized by an image processing software to form a signature for orientation. For instance, distances between three or more anomaly or signature centers may serve to provide local coordinate systems for orientation.

Another embodiment that can serve to provide a quasi-three-dimensional representation or image of a user's posterior region can be acquired when the cameras depicted in multiple figures in this disclosure, such as FIGS. 1-3, 6, 7, 7B and others are replaced or augmented by 3-D scanners such as those used for light detection and ranging (LIDAR) measurements. By reflecting scanned laser beams off the surface of a user's posterior, an accurate three-dimensional image of topography can be acquired, which serves to characterize, among others, anomalies and potential health related issues by additional topographic signatures. For miniaturized LIDAR scanners, we envision the same basic mechanisms for engaging and retracting for operation and idle stages, respectively, as well as placement at different points utilizing one- or more dimensional motion of said cameras or scanners.

Additionally, the same encapsulation and automatable cleaning and drying of said camera or LIDAR scanners is envisioned. LIDAR at different wavelengths, including different visible and infrared wavelengths can serve to provide a multitude of information, including information from subcutaneous regions, allowing early detection of anomalies as they evolve, potentially prior to breaking through the skin surface for such anomalies which develop underneath the skin.

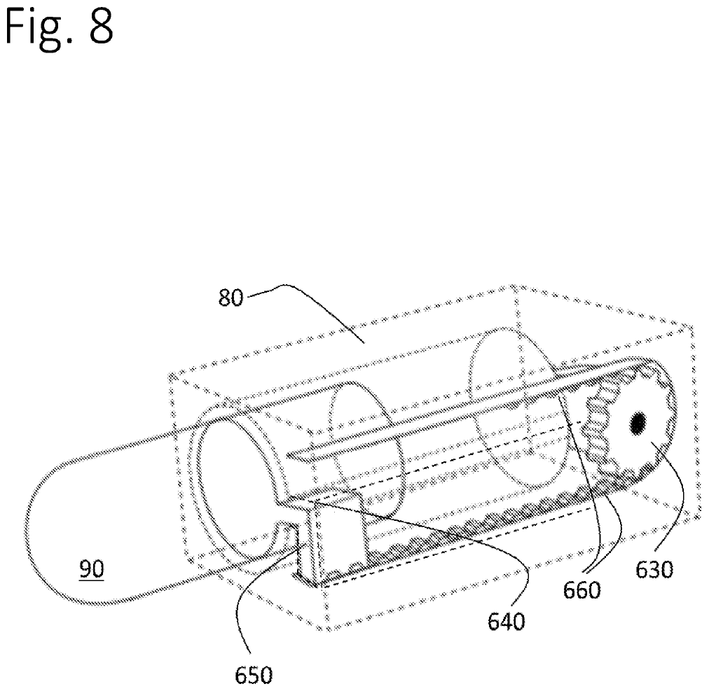

FIG. 8 shows the described telescopic camera mount body 90 embedded in a telescope housing and guiding block that also contains the drive mechanism 80. The telescope housing and guide block may optionally contain a door in the front, which can be closed by spring action or gravity when the camera telescope body is fully retracted. Said door is described later in this disclosure and said door can contain outlets for rinsing and drying the tip or front region of the camera telescope body. The telescope guide block also contains a slit 640, here shown in an L-shaped cross-section along one of the sides of the telescope guide block. Said slit acts as a side guide which allows for a segment 650 of the camera telescope mount body 90 which may be for instance formed in an L-shape or similar and protrudes out sideways to be guided and moved. Said protruded side segment 650 contains features to render it drivable by the use of an actuation mechanism, such as for instance a worm gear rod or a toothed belt or flexible toothed chain 660. Said toothed belt, toothed flexible chain or worm gear itself can be driven by a wheel gear 630 with sprockets which is driven by a motor, the camera telescope motor.

Through sufficiently tight guidance of the protruding segment along the slit and coupling of the drive mechanism (belt, chain, worm gear rod), the telescope position can directly be inferred from the motor position, such as the motor steps, or through the use of a motor encoder or the likes. The same holds for the motor and mechanism driving the bidet telescope. With this information, position of bidet rod with water jet and camera can both readily be inferred.

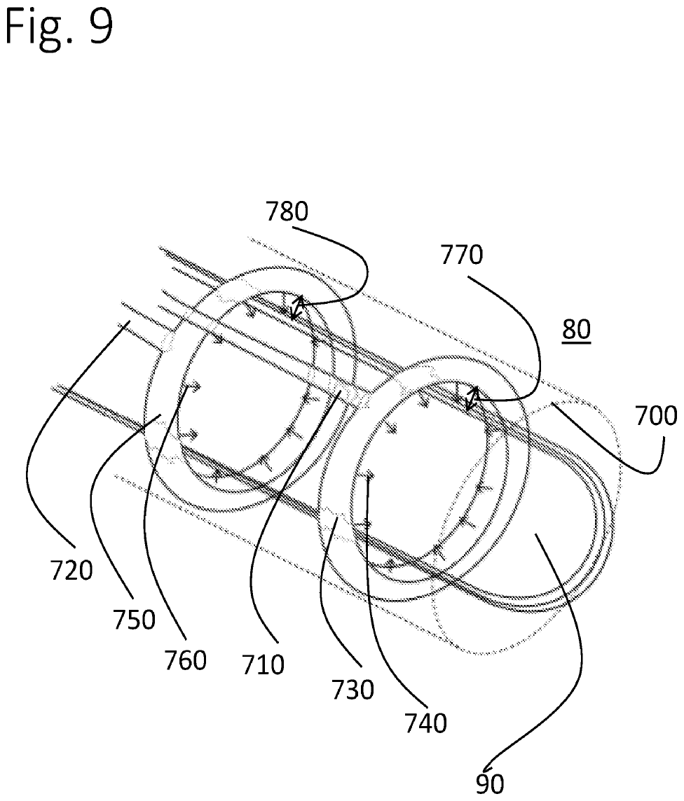

FIG. 9 depicts cleaning and drying mechanism and components for the telescopic camera mount body.

Shown here is an outline of the inner part of the housing of the camera telescope guide housing block 700 of the camera assembly 80 (removed for clarity), with integrated cleaning or rinsing fluid (typically water) line 710 and drying gas (typically air) lines 720 (tubes, bores or injection molded solutions possible) for rinse-cleaning and drying the camera mount body 90. Said fluid line leads to an essentially ring-shaped assembly of cleaning nozzles 730 that are capable to clean the circumference of the camera telescope body. Said cleaning nozzles are preferably directed both inward towards the camera telescope body as well as outward towards the front and towards the toilet, as arrows 740 show. Most easily the spent rinse water is discharged into the toilet. The mentioned drying line leads similarly to an essentially ring-shaped assembly of drying nozzles 750 that are capable to dry the circumference of the camera telescope body. Said drying nozzles are preferably directed both inward towards the camera telescope body as well as outward towards the front and towards the toilet, as arrows 760 show. Most easily the spent drying air is discharged towards the front into the toilet. The ring nozzles for both fluid and air can also be devised as slits or just single or few port outlets, depending on the cleaning and drying capability requirement. Said fluid and air can escape from the region due to the fact that the camera telescope body and the telescope guide are not hermetically sealing, but there is a small but sufficiently large gap 770 between the ring rinse nozzle and the camera mount body and also a small but sufficiently large gap 780 between the drying nozzle and the camera mount body, each gap signified by an dual tipped arrow.

Preferably, the rinsing and drying is done while the camera mount body is retracted after use and passes by the ring nozzles. However, the same can be done as the camera mount body is moved forward past the ring nozzles. The drying line and nozzles can be run during the cleaning process as well, while the rinse water is on, thereby reliably driving the rinse water towards the front and preventing back flow of rinse water. In addition, the telescope direction is arranged such that while the motion is essentially forward into the toilet bowl and backward out of the toilet bowl, there is an additional downward component for the telescope as it moves into the toilet bowl. This downward tilt also contributes to readily guide spent rinse water from the array into the toilet bowl.

In a simpler embodiment, rinsing water and drying air may use the same lines, just subsequently. For that it may be advantageous to have the camera telescope body oscillate more than once past the rinsing/drying nozzle, first for rinsing, then for drying.

If surface materials are chosen or engineered to be hydrophobic and potentially antimicrobial, only small amounts or rinsing and especially only a short time is required for drying. The drying time is also shortened by the smooth, preferably round or oblong, lightly downward tilted cross-section of the camera telescope body, at least in the exposed regions.

The preference for rounded surfaces does not preclude the use of straight surfaces, preferably with rounded edges, to accomplish the same mechanisms described here and, as with other readily transferred thoughts, this disclosure seeks to teach and cover all such embodiments and realizations.

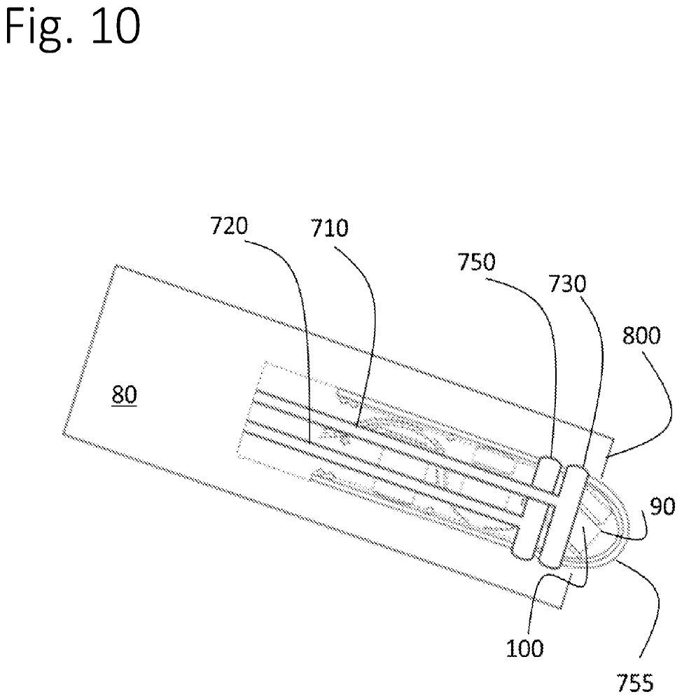

FIG. 10 depicts the same assembly and mechanism as the previous figure, yet from a direct side view. Depicted are rinsing line 710 with ring rinse nozzle 730 and drying line 720 with ring drying nozzle 750. It is significant and advantageous to mount rinse and dry nozzles closely to the front edge 800 of the guide body 80, such as to be able to address and clean the tip 755 of the camera telescope body 90. Ideally, in a fully retracted position, said tip 755 should be retracted further inward from rinse and drying line. Should this clean not be adequate, the tip of the camera can also be cleaned by rinses emanating from the front door of the assembly, which is not shown in this figure, but instead described in subsequent figures.

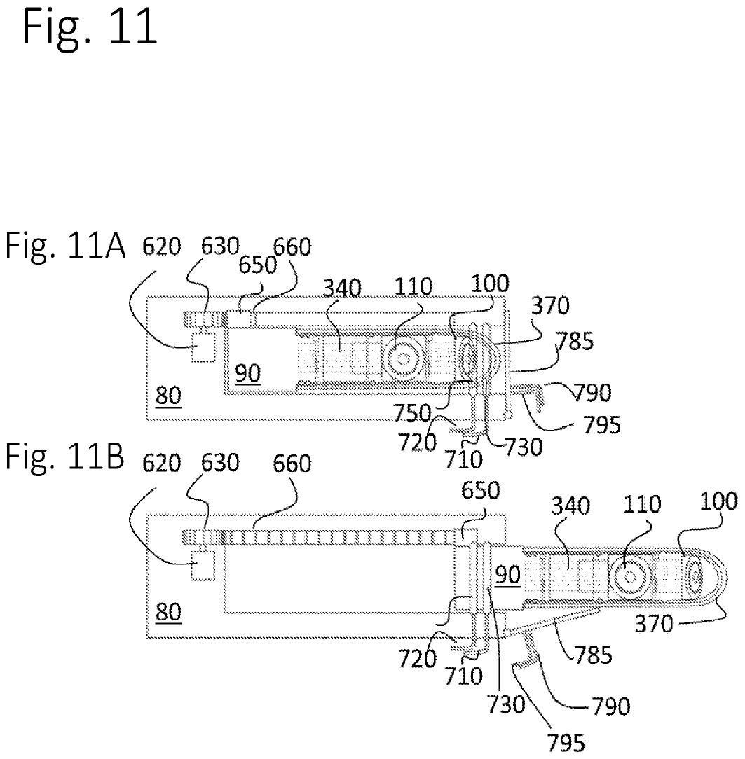

FIG. 11 shows a top view of the camera device telescope housing assembly 80, with the telescopic guide block, the telescopic camera mount body 90 in fully retracted, idle position (FIG. 11A) and in fully extended position (FIG. 11b). Forward 100 and upward 110 looking cameras are also indicated, and so are camera cables 340 and the at least partially transparent camera cover 370. Also shown is the drive mechanism for the camera telescope body with drive motor 620, sprocket gear 630 and translating toothed belt, worm gear or chain 660, with a segment 650 of the camera mount body 80 protruding out (top in figure), said protruding segment 650 being engaged to a drive mechanism 660 such as a worm gear, toothed belt or flexible toothed chain. The figure shows the maximum travel range of the camera telescope body, given by the maximum travel range of the protruding segment of the drive mechanism. In addition, across from the drive mechanism side, the rinse line 710 and dry lines 720 are shown, leading to rinse 730 and dry 750 ring nozzles. FIG. 11 also introduces a protecting front door 785, which protects the camera mount body 90 and the camera drive assembly 80. In FIG. 11A, this optional front door is closed, for instance using gravity or a spring loading mechanism. FIG. 11B illustrates how the door 785 is pushed open when the camera mount body is moving into an active position. Also shown in both figures are optional door mounted rinsing line 790 and door mounted drying line 795. Such additional rinsing and drying capability can be advisable if rinsing and drying through ring nozzles 730 and 750 are not sufficient for reliably retaining a clean and dry front edge of the camera mount body 90.

Also depicted in these figures are the essentially upward looking cameras 100 and 110. Flat camera cables are also indicated. Camera cable travel and camera controllers are not shown in these figures. They are indicated in subsequent figures.

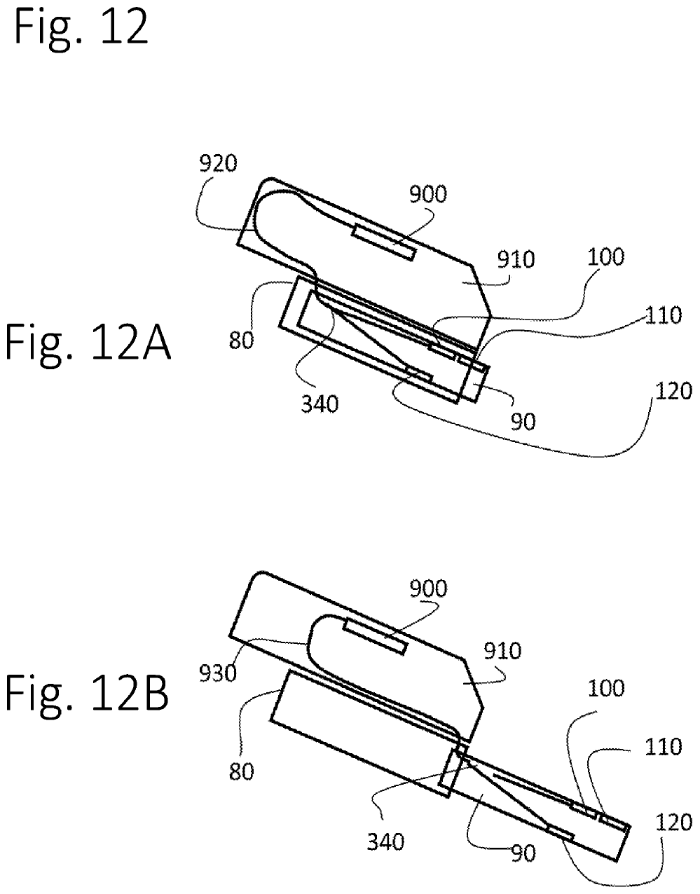

FIG. 12 contains a simplified illustration of the telescope camera mechanism with housing, guide and drive assembly 80 and camera mount body 90 with cameras 100, 110, 120 from a side view, with an emphasis on the camera cable routing. Only the camera telescope guide block 80 is shown. Also depicted is the camera telescope mount body 90, both in fully retracted position (FIG. 12A) and in fully extended position (FIG. 12B). The camera cables 340 are shown, leading to the camera controllers 900 with the WiFi, Bluetooth or other components and antenna integrated. In this embodiment, said camera controllers do not move. As the camera telescope body is moved in and moved out, the camera cables are moved in a gentle way and within a guided cable routing casing 910 which protects the cables from getting kinked or wear out over time. The camera controllers typically will have a power supply cable, which does not need to move in this embodiment. In this embodiment, the camera controllers are also enclosed in said casing 910. However, it is also conceived that the camera controllers remain outside of the casing and only cables run in the casing. FIG. 12A shows the cable in the casing with slack 920 as the camera mount body 90 is in the retracted position and FIG. 12B shows the cable with almost no slack 930 when the camera mount body 90 is in its fully extended position. Also envisioned is the use of small geometry cameras which have their readout chip directly attached to their image sensor base in a small formfactor. In such embodiments, the number and size of cables to said cameras is reduced significantly, as a video signal can be conveyed on one line, while other lines bring power to the assembly.

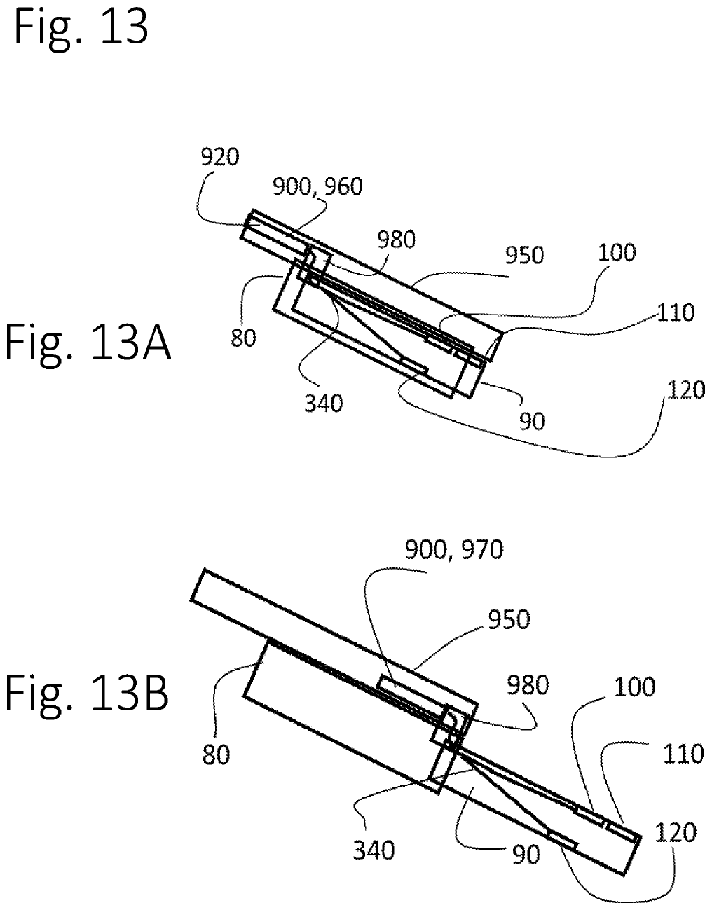

FIG. 13 illustrates another mechanism of enabling the telescopic camera motion. FIG. 13A depicts the camera mechanism 80 with camera mount body 90 in retracted, idle position, while FIG. 13B depicts the mechanism with the camera mount body 90 in maximum engaged position. Here depicted is an embodiment where the camera controllers 900 move directly with the camera telescope body from retracted position 960 in FIG. 13A to engaged position 970 in FIG. 13B, but camera controllers are physically sufficiently separated to not be exposed to any wet ambient and optionally encapsulated by housing 950. This assembly requires a larger space for its motion; yet it does not require the camera cables to move relatively between camera and camera controller with antenna. The cable which does require movement for this embodiment is the power supply cable to the camera controller. A preferably rigid connection 980 between camera mount body 90 and camera controller 900 (960, 970) should be used to facilitate smooth parallel movement of camera mount body and camera controller.

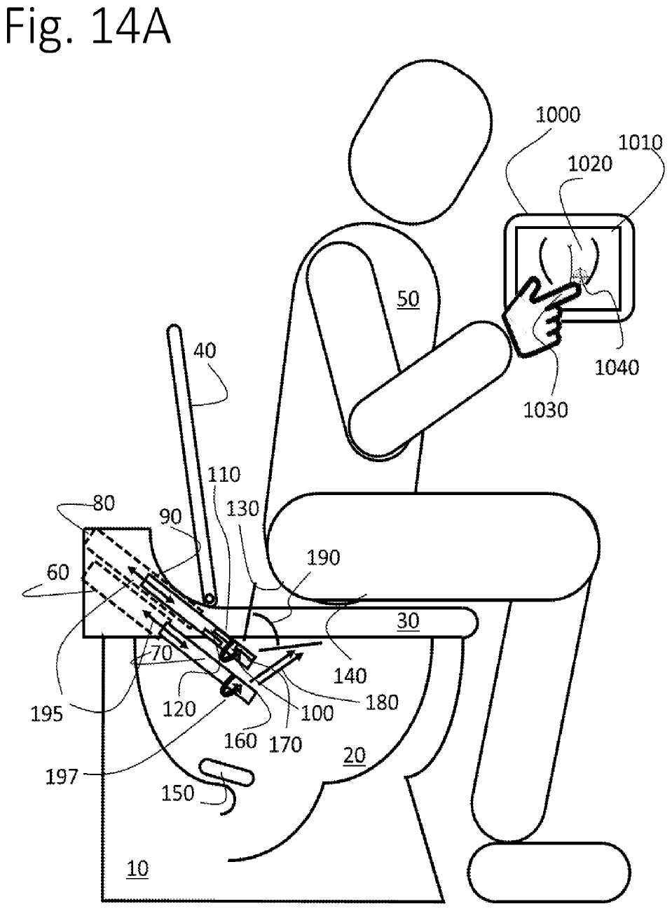

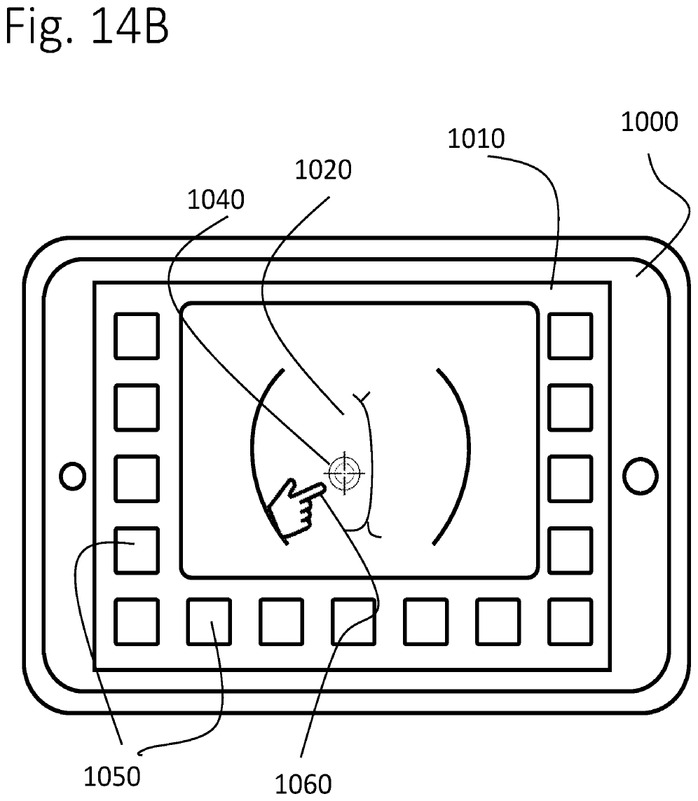

FIG. 14A depicts a toilet device 10 with toilet bowl 20, toilet seat 30, integrated bidet function 60 with bidet tube 70 for cleaning, integrated camera device for observation 80, a toilet user 50 and a smart device 1000 such as a tablet or smartphone with video touchscreen 1010 displaying one or more of images taken using cameras 100, 110, 120, implemented in camera mount body 90, in this example an image 1020 of the user's posterior thus allowing the toilet user to observe and inspect their posterior 130 or genital region 140 and observe, inspect and control the cleaning activity performed by the bidet cleaning device 60 with bidet tube 70 moved into cleaning position 160 and dispensing cleaning jet 180. The unit's controller system, by tracking current positions of all motors that drive bidet tube 70 and camera mount body 90, determines the location where the cleaning fluid jet, usually a water jet, is to hit the surface of the user when used in current position of user and bidet tube 160, and places a marker 1040, such as a cross-hair or similar, on the screen for the user. The way the controller determines the contact location of the water jet is by evaluating one or more of the following, and ideally as much of the following as is economically possible: a) The camera location is determined by the camera telescope drive motor status, which can be determined for instance either via an encoder or via counting steps if a stepper motor is employed. In the case of stepper motor step counting action it is advantageous to have the stepper motor and telescope hit a hard stop home location with every use, in order to not have any errors accumulate. b) The camera may use an auto focus function or distance finder to determine the location of the user's posterior or genital surface. Alternatively, an estimate of average user depth position can be determined. In addition, it is possible to take images of the user's posterior at different extracted positions of the camera mount body and use image shifts and size changes to locate the depth of the user's posterior. c) The controller may use basic geometry such as the inner outline of the toilet seat as reference. For instance, markers along toilet seat rim or the toilet seat rim contour itself can serve as additional location references. d) The bidet telescope motor or motors uses a similar function as the camera telescope motor to determine the in-out position of the bidet fluid jet port. Should the bidet telescope have an additional degree of motion, such as a motorized (or otherwise driven) rotation 197 around the long axis, as indicated in the figure, then that second motor's position is also recorded to add to the information regarding the position and direction of the bidet fluid jet. e) The water pump supplying water to the bidet fluid jet is motorized and with relatively fixed fluid path geometry between water pump and water jet outlet, the water pump speed and possible aeration determine the trajectory of the water jet.

With all this data, the system can calculate and place an estimated striking position 1040 onto the screen. The user can have options to change the target location by e.g. using their finger 1030 to touch a desired area to be cleaned on the touch screen. That location is then translated back to the system and the motor(s) of the bidet tube are programmed to hit the desired area. The directions of motion, such as translational movement 195 and rotational movement 197 of the bidet function can both be used to execute a certain desired cleaning routine in an area determined using the controller touchscreen. For optimum accuracy, the system may allow for corrective alignment settings or use factory settings and use said crosshairs for targeting locations or patterns to clean. Instead of a touch screen, it is also conceived to use a joystick or similar, or to use voice activation or other help for users with impaired motion of their upper extremities.

For the rotational motions, it is envisioned that such motions can either be implemented independently for bidet tube 70 and camera mount body 90, or be done in one combined, coupled motion or by one motion that for instance rotates the entire bidet tube housing and camera device housing around its axis.

FIG. 14B shows a larger view of an example screen image 1020 on a touch screen 1010 of a smart device 1000, such as a tablet or smartphone, or dedicated toilet controller device, where the utilization of such location is demonstrated. The image 1020 indicates a user's posterior and crosshairs 1040 placed where the fluid jet is to hit. For instance, the user can be given a second crosshair or an indication where exactly his finger is touching the screen, such as a finger icon 1060 or similar and use a joystick or touch-screen motion to describe, with their fingers or the joystick, a desired cleaning pattern on the screen or circle and, for instance by a circling motion, select the area to be cleaned, or do a voice or foot command if desired if the user does not have full functionality of their upper extremities. By describing the marking area as circling, we explicitly state that the region does not need to be of circular shape, but may for instance include an area circumscribed using a freestyle line or any similar measure.

Such control or guidance can be done using the live image and be done during the clean itself, in real-time observation, or it can use a stored image that was taken when the water jet is not on, as such image will tend to give better visibility, but accuracy then relies on the user not moving the surface as it is being cleaned. Or the process can be done intermittently with turning the fluid jet on and off in quick succession in order to get updated images of the cleaning status. It is also envisioned that the user merely circles an area to be cleaned and the system executes a cleaning pattern around this area. Or the user directly guides the cleaning stream and controls via live image (or intermittent live and stored image for location, or via image view with intermittent water jet on/off for image quality). Various embodiments of such direct and enhanced cleaning control, with and without the use of cross hairs or the likes, and with and without the use of intermittent images, are imaginable and are considered covered by this disclosure. For instance, instead of cross hairs, an LED or laser which is aligned with the water jet path can be used to illustrate to the user the location where the water jet is to hit the surface. It is readily conceivable to have laser light or otherwise adequately focused light coupled in near the tip of the water jet nozzle and be emitted essentially concentric with the water jet path. Gravity based corrections may need to be applied, their degree depending on the strength of the water jet. However, the water jet itself guiding the laser beam to an extent, via total internal reflection, is also a known phenomenon and may be employed here if desired.

Regarding the cleaning fluid jet, it should be noted that while a circular hole with circular fluid jet pattern is readily implemented, it is also conceivable to use a fan spray which covers a larger area per unit time and can provide a quicker clean in certain circumstances, especially when combined with a programmed sweeping pattern.

FIG. 14B also indicates various other user accessible touch control buttons 1050 for other control functions having to do with the bidet function and adjustment as well as with camera control, such as image switching, image acquisition, image or video storage and the likes. Overall, the control of the whole device is conceived as being downloadable as an App onto a user's smart device, or to run directly on a control device dedicated to the toilet device with enhanced control and support functions.

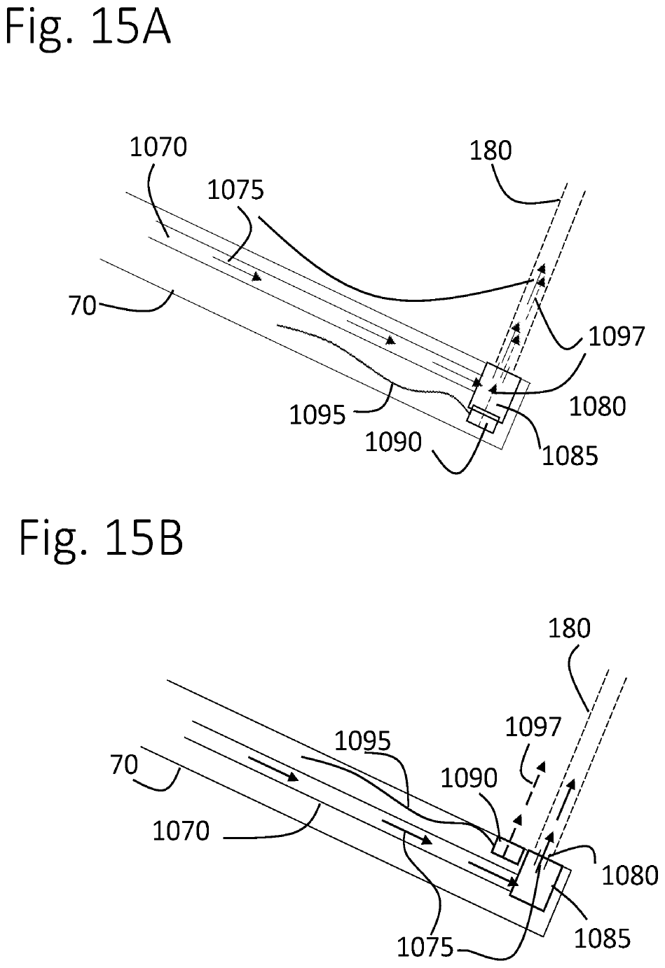

FIG. 15A depicts a bidet tube 70, containing a cleaning fluid or water tube 1070 and nozzle 1080, as well as a laser or point light source 1090 with supply cable 1095 arranged such as to shine light concentrically and in the same direction as a cleaning fluid or water jet 180 emanating from said cleaning fluid nozzle. Fluid or water tube 1070 and nozzle are connected via tube-to-nozzle connector 1085. Point light source 1080 couples light in through a transparent bottom of said tube-to-nozzle connector 1085. Water or cleaning fluid direction is illustrated by solid arrows 1075, while light from the point light source is indicated by dashed arrows 1097.

FIG. 15B depicts a bidet tube 70, containing a cleaning fluid or water tube 1070 and nozzle 1080, as well as a laser or point light source 1090 with supply cable 1095 arranged to shine light in parallel and close proximity to a cleaning fluid or water jet 180 emanating from said cleaning fluid nozzle 1080. Water or cleaning fluid direction is illustrated by solid arrows 1075, while light from the point light source is indicated by dashed arrows 1097.

With such an arrangement utilizing a point light source, the image 1020 on monitor 1000 in FIG. 14B may thus directly visualize the spot on the user's posterior or genital skin surface so that in place of projected crosshairs 1040, the point light source or laser spot is directly visible to the user. The user can then use this spot to direct the cleaning fluid jet to wherever specific cleaning by the cleaning fluid or water jet are required.

Drying of the user's posterior or genitals after the cleaning process is typically done by a warm or hot air fan which is stationary. But it is also conceivable to do drying, or part of the drying, using compressed air, for instance using a parallel hole pattern or fan pattern to shear off the water from the user's posterior or genital surfaces. Such compressed air drying can be combined with a telescopic or sweeping or shearing motion akin to the bidet telescope motion, in order to cover the wetted region quickly. Such shearing motion is best and safest done by using a somewhat grazing angle towards the surface, such that the drying air rushes toward the surface at a low angle, far from vertical impingement. This yields the best drying results as well as the lowest impact. Such compressed (or fast) air drying can be accompanied by an active (negative pressure) air extract or just by a shield that is on the opposed side from the air outlet. The function of that is to retain the fluid droplets within the bowl and not let them be driven out of the bowl by the compressed air.

Such extracts or shields should include automatic cleaning as well, to prevent accumulation of dirt or microbes.

Such compressed air drying can be used by itself or combined with hot air drying, to accelerate the overall drying process.

Example embodiments of such enhanced drying process capabilities are described further down in this disclosure.

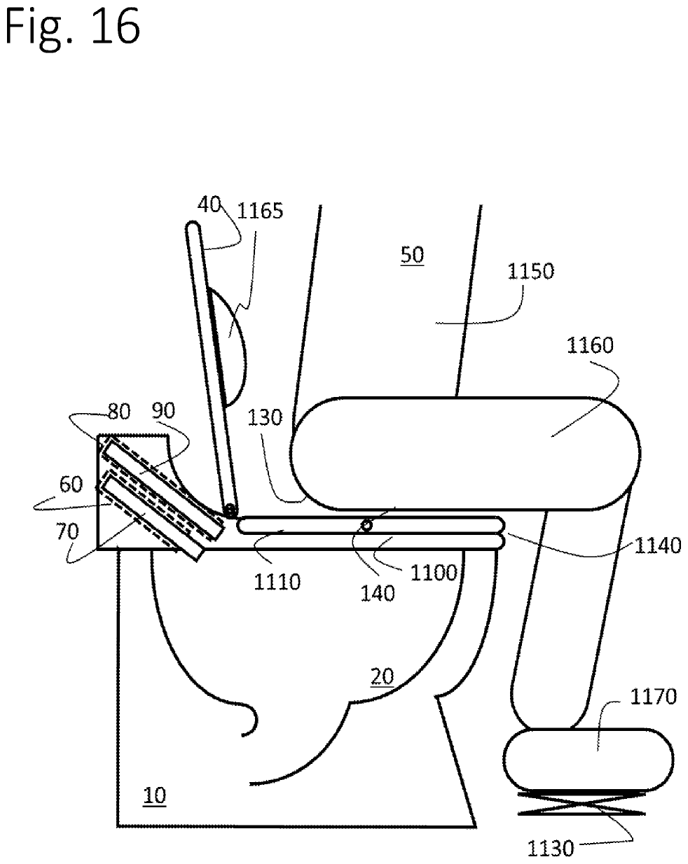

FIG. 16 illustrates a toilet device 10 with toilet bowl 20, toilet seat cover which doubles as potential back rest 40, toilet seat 1100 with actuation, in idle position, preferably with an upper and a lower seat segment, signaled by a dividing line 1110, a front seat segment 1140 in flat idle position and optional telescopic bidet function 60 as well as telescopic camera observation function 80. Backrest 40 contains an inflatable back support 1165, depicted as uninflated. In FIG. 16, the toilet user 50 is seated such that the user's torso 1150 and thighs 1160 are arranged in an essential L-shape. User's feet 1170 are placed on an actuatable, compressed foot stool 1130. The device depicted here and in the next figure emphasizes functions and mechanisms to help the user with their bowel movement process. It will become clear from the description that the described functions and mechanisms are of particular importance and advantage to people that are either suffering from lack of sensation in the region, such as paraplegic or quadriplegic people, but also to people of diminished or waning physical strength or coordination. It is well known that a crouching position can help a user with a bowel movement. A rocking motion can support this as well, and so can stimulation of the anus using a fluid jet 180, potentially specifically an aerated or pulsed fluid jet. This disclosure also describes how the position of the pulsed fluid jet can be observed and controlled precisely by means of previously described camera and visualization system, such as touchscreens of smart phones. This helps in providing a well targeted stimulation. The devices, structures and mechanisms described here are all geared to provide the user with such supports.

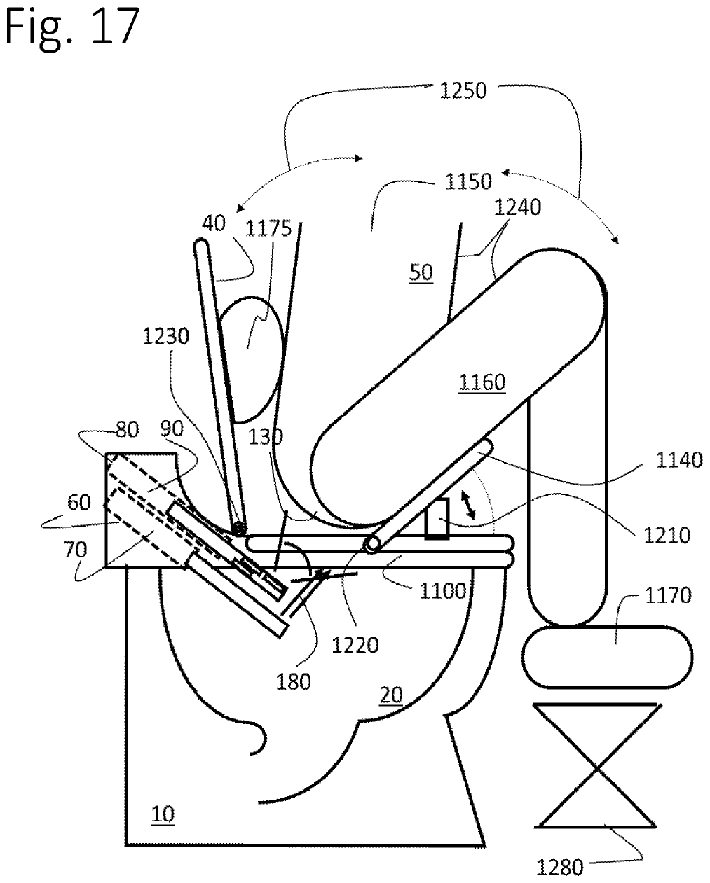

FIG. 17 shows the concept of a toilet with several actuation functions, including lifting the user's thighs, supporting the user in a partially crouched position where the user's upper leg and torso resemble a V shape. It shows the toilet device 10, with toilet bowl 20, toilet seat with upper and lower segment 1100, toilet cover as back rest 40 with inflated back support 1175, an optional foot stool with motorized lifting capability in an actuated elevation position 1280, and the user 50.

Shown here is an engaged actuation wherein the upper segment of the toilet seat has a front section 1140 that is lifted by actuation, for instance by a scissor lift-like actuator 1210 with motor. In addition, the back rest may be motorized in a similar way (actuation not shown here). The foot lift is in an actuated elevated position 1280. Said front seat section is lifted and pivots around pivot point 1220. The toilet cover or back rest 40 may pivot around pivot point 1230. The toilet cover or back rest may have an inflated back support 1175. Said inflation can optionally be carried out on command. It is envisioned that a pressure sensor and cutoff or limit switch are used in order to prevent a user from experiencing an excessive squeezing force when being brought into said V-shape. One convenient option for such pressure sensing is the direct sensing and control of the pressure of the inflated back rest. In order to cover the gap between upper and lower segment of the front part of actuatable toilet seat 1100, a collapsible skirt can be envisioned, said skirt itself being rinseable if required. Similar to the front upper segment of the seat, the rear upper segment is also envisioned to be liftable in similar fashion. In the lifted position, the user's torso 1150 and thighs 1160 essentially form a V-shape 1240, thereby applying pressure on the user's bowels and supporting the initiation or continuation of bowel movement. The motions of the various actuators can be combined in such a form that the user, while in a V-shaped position, can be rocked back and forth in combined or separate motions 1250, wherein motion of the toilet seat cover or back rest, the front section of the toilet seat and the foot stool 1280 can be coordinated to form a rocking motion where the user's torso and upper legs are cradled and move synchronously, or in a squeezing motion, wherein user's torso and upper legs alternately form a V-shape or an L-shape. Said rocking or squeezing motions may be beneficial to the user's bowel movement.

In addition, the user can choose to stimulate the bowel movement using the fluid jet 180 from a telescopic bidet function 60, as described earlier in this disclosure to carry out an enema or to stimulate the anal region to trigger or support a bowel movement. The procedure and progress, as well as subsequent cleaning, can be observed, guided and controlled using the telescopic camera mechanism described earlier.

It is to be noted that in order to enable such mobile toilet seat segments, it is advisable to have a hygienic, soft or semi soft cover on the toilet seat, such as from an elastomer, which can itself be supported in segments. Preferably such a hygienic flexible elastomer covers the seat hermetically but is also easily removable for cleaning.

It is also noted that differing arrangements and actuations for cradling, rocking or squeezing the user to induce bowel movement are also envisioned and included to the fullest extent. Examples are to have a rear section of a seat actuatable as well, or to have a toilet seat with a surface that can conform to a user for optimized cradling during the rocking or squeezing motion. Preferably, actuatable surfaces may be covered with a flexible, yet hermetic and sanitary material, perhaps with a foam layer, in order to separate the user's buttocks and rear thighs from pivot points or actuation mechanisms and prevent any of a user's skin to be caught within a pivot point or actuator.

Placing a user into a squeezed position by the above described example actuation mechanisms can also serve to improve imaging of a user's posterior or genitals for diagnostic purposes, especially in such cases, where skin creases can be smoothed and the actuation serves to temporarily spread, stretch, smooth and thus expose the regions of diagnostic interest, namely anal and genital regions. Furthermore, the same action can facilitate improved cleaning and drying of said regions after bowel movement, as it makes the region overall more accessible for the cleaning fluid jet or jets.

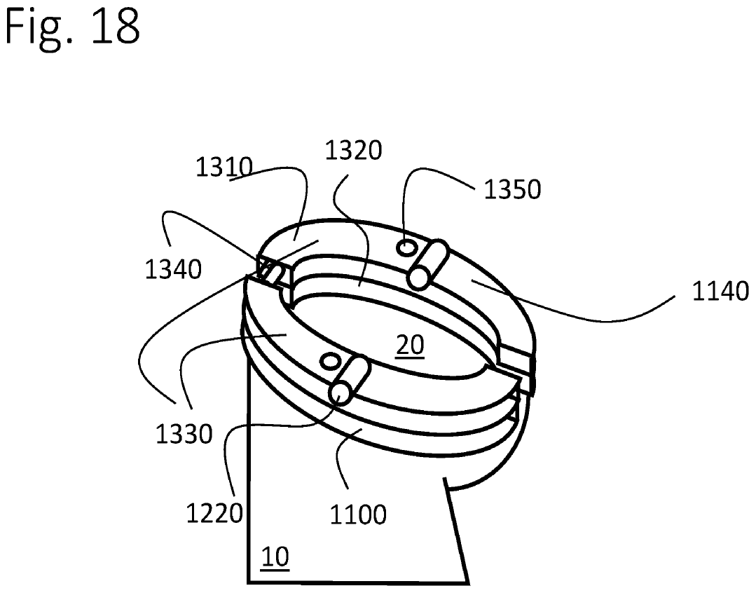

FIG. 18 shows an additional actuation with the same improvement goals to bowel movement, post-bowel movement cleaning, drying and imaging. It shows a toilet device 10 with a toilet bowl 20 and toilet seat 1100, which is segmented between an upper 1310 and lower toilet seat 1320, wherein said lower toilet seat segment is more or less stationary whereas the upper seat segment can be actuated. In the described embodiment in this figure, the rear upper segments 1330 of the toilet seat can be spread apart, such as to support spreading the buttocks of a toilet user sitting on said seat. The actuator for the lateral spreading 1340 is preferably located near the rear of the seat and is preferably covered by the afore mentioned hygienic, hermetic and flexible elastomer seal (not shown). Upon actuation, the rear upper segments 1330 of the toilet seat are spread and pivot around pivot points 1350 located further forward on the toilet seat. Such spreading is to support the bowel movement of the user as well as cleaning and diagnostic imaging information, in much a similar way that the afore described thigh lifting and rocking or squeezing motion does.

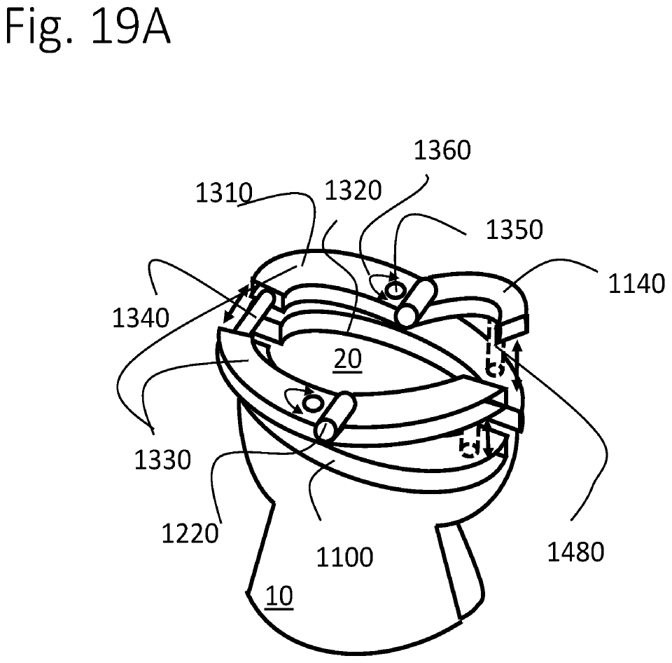

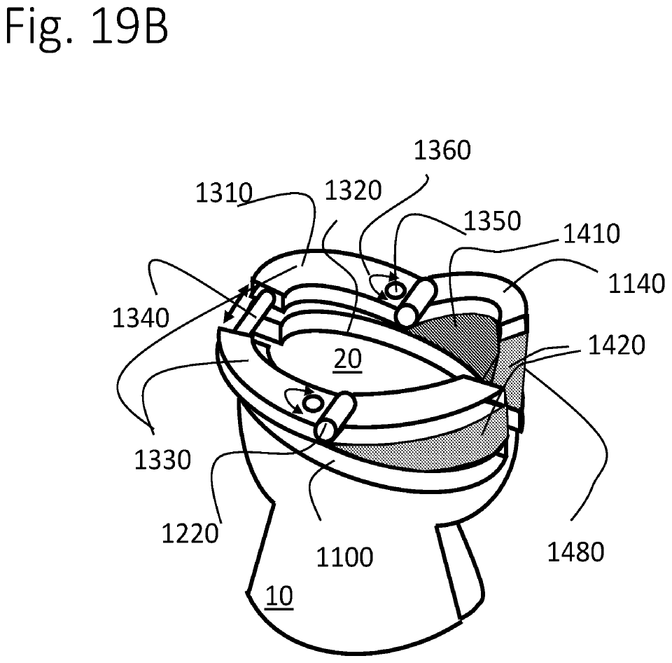

FIG. 19A show a toilet device 10 with a toilet seat 1100 consisting of an upper 1310 and a lower segment 1320 wherein said toilet seat combines the actuation mechanisms described in the previous figures and shows the features in the actuated state. The figure indicates how the front section 1140 of the upper segment of the toilet seat can be lifted in order to lift the toilet user's thighs, while the rear section of the upper segment of the toilet seat can be spread, and optionally also be lifted, even though that motion is not shown explicitly in this figure. The frontal lifting occurs around pivot points or hinges 1220 located closer to the middle of the toilet seat. As mentioned for the other figures, it is advantageous for hygiene and safety purposes that the seats and their actuation mechanism 1480 with actuation direction 1490 be covered by a preferably hermetic yet flexible elastomer seal, not shown, which also contains the skirt that covers the gap that is generated when the frontal upper segments of the toilet seat are lifted. The rear upper segments 1330 of the toilet seat are also depicted in actuated, spread mode, spread symmetrically around pivot points 1350 with pivot rotation direction 1360. The actuator 1340 for this motion is also shown. Preferably all actuation mechanisms are covered by flexible elastomer seals, which are not shown.

FIG. 19B shows the same embodiment of a toilet device as FIG. 19A, except that inner skirt 1410 and outer skirt 1420 are also depicted. Both skirts have the function of keeping the user safe from getting their skin caught in actuation functions. They also serve to protect the actuation functions. In addition, inner skirt 1410, which may be contiguous along the front side of the toilet seat also serves to prevent any liquid, be it urine or cleaning fluid, from accidentally being released from toilet bowl 20, especially while the seat lifting elements are actuated.

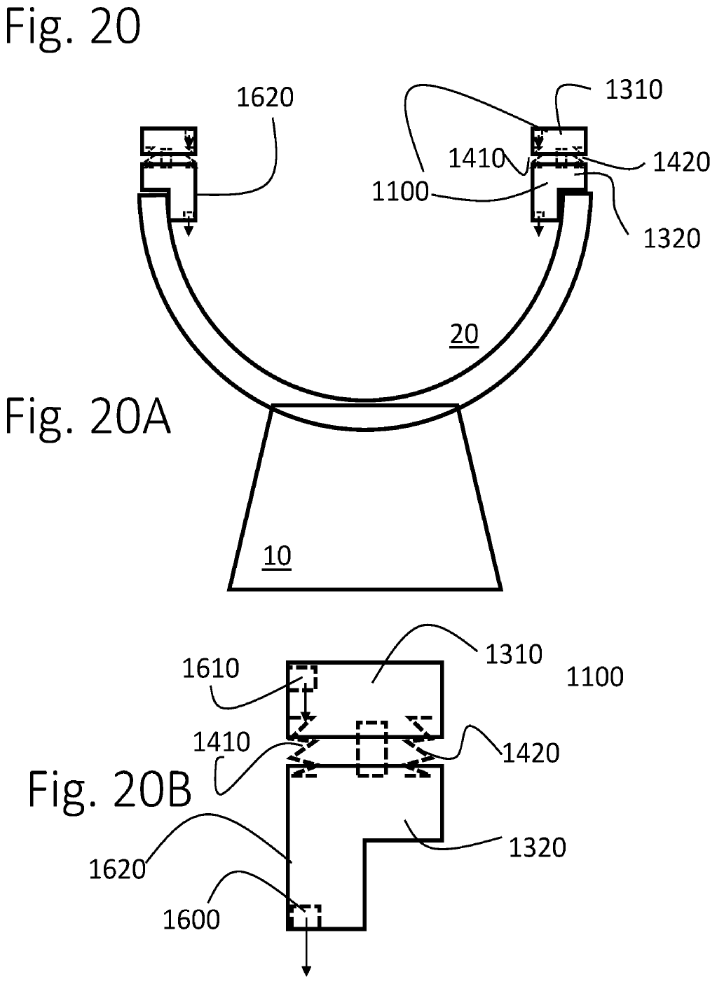

FIG. 20A shows a cross section of a toilet device 10 with toilet bowl 20 and with toilet seat 1100 with segmented upper 1310 and lower segments 1320. FIG. 20B shows a larger view of a segment of the toilet seat cross section region. Depicted here is the hermetic inner 1410 and outer 1420 seal, which is compressed in an accordion shape between upper and lower seat segments 1310 and 1320, respectively. Also indicated is a rinse line with rinse nozzles that can be used as a toilet bowl sidewall rinse 1600, as well as a rinse for the skirt 1610. In a similar fashion, a drying line for post rinse drying is also envisioned. The figure also indicates how a lower part of the lower toilet seat segment 1620 is integrated and obscured by the toilet bowl, mainly for aesthetic or architectural reasons, since particularly the lower segment needs to house actuators of substantial size in order to lift or move the user's thighs or rock the user back and forth on the toilet seat.

FIGS. 16-20 describe embodiments with actuations for a toilet seat, where the toilet seat has an upper and lower segment. Such embodiments lend themselves to be used as retrofits to existing toilet bowls. In addition, the segmentation has certain maintenance advantages, as described. However, it is also envisioned that the lower segment can be part of an integrated toilet itself.

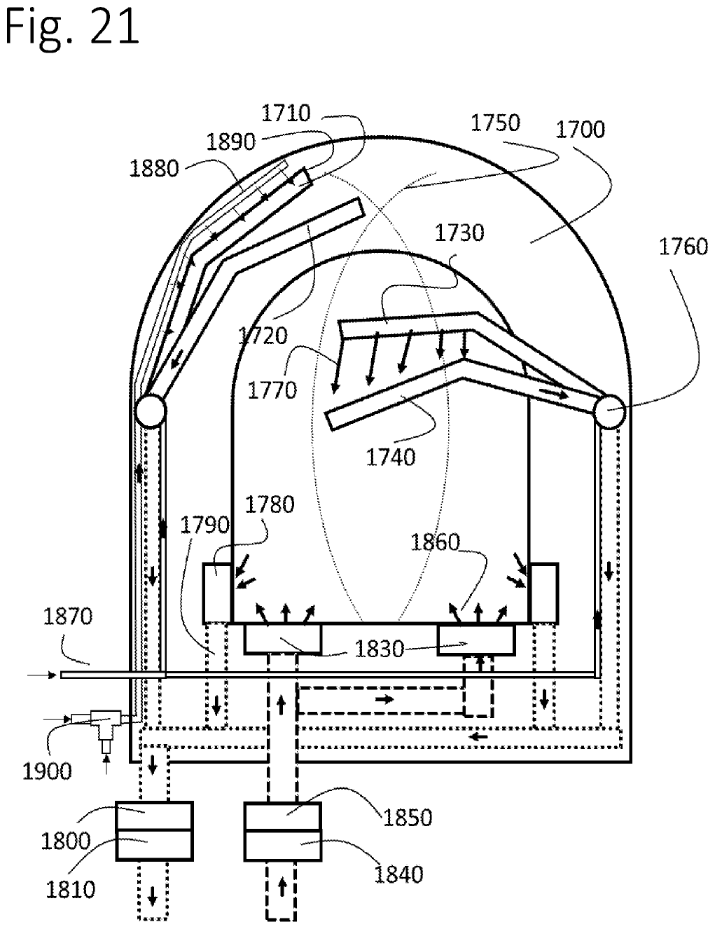

FIGS. 21-23 depict example embodiments for enhanced drying mechanisms.

FIG. 21 depicts a toilet seat 1700, seen from below, with an arrangement for drying the user's posterior. A Motor driven air knife bar 1730 e.g. on each side of the toilet seat is presented which pivots around a pivot point 1760 and sweeps across at least one side of a user's posterior, in this embodiment sweeping from front to rear of a toilet seat along path 1750. Said air knife bar has a resting position 1710 tucked into or underneath said toilet seat. Compressed air is fed into the air knife bar via duct 1870. The air knife bar is optionally accompanied by a driven air extract bar e.g. on each side of the toilet seat which also has a resting position 1720 and which is moved 1740 in connection with said air knife mechanism, preferably preceding the air knife on its path from front to rear of said toilet seat, such as to catch air and droplets from drying the user's posterior and extracting them through air ducts and optional filter with optional heating or other moisture trapping capabilities. Said air extract is preferably powered by an air fan 1800 generating an air suction force sufficient for efficient collection of the droplet-laden drying air and driving it out through an air extract filter 1810. FIG. 21 shows one air knife 1730 with extract arrangement 1740 being swept across the open area of the toilet seat, while the other side's air knife 1710 with extract arrangement 1720 is still in its resting position, nested within the toilet seat. Drying air direction 1770 from the air knife is also indicated via arrows.

In said resting position 1710 and 1720, respectively, it is advantageous to provide a rinsing and optional drying capability 1880 of said air knife and extract mechanism, such as to keep the mechanism clean at all times. In such a cleaning with optional drying setup 1880, it is envisioned that cleaning fluid, typically water or water enhanced by a cleaning chemical, can be delivered to said air knife also in a multi-nozzle arrangement and fluid and water lines can be separate or joined. For the latter case, the drying air used to dry the air knife and air extract mechanism acts to drive out the residual fluid through the cleaning line and then dries the air knife. Arrows 1890 indicate the direction of air knife rinsing and drying liquid and air. Rinsing fluid and drying air can be fed into the duct by T-connector 1900. Such cleaning and drying of the air knife may also cover the air extract bar 1720 and it is a quick process. Even so, it can even be finished after the user has left the toilet, when air knife and air extract mechanism are back in resting position. If a user so choses, it is evident that such air knife cleaning and rinsing in place can also be done prior to applying the air knife for drying the user's posterior. It should be mentioned that instead of using a separate motor to drive the air knife and air extract mechanism, it is also conceived that a portion of the drying air itself which is used for the drying is also employed to actuate the air knife bar, since this drying air contains a certain kinetic energy and its momentum can be used to impact and repel/propel the air knife from a position. In such cases, a spring loading mechanism can also be employed for instance to drive the air knife bar back into its resting position.

In addition to the drying of the user's posterior or genitals by said air knife, additional hot air drying can be employed to hot air feed ports 1830 via a hot air fan 1840 and heater 1850 at the same time or after the air knife. Arrows 1860 show the general direction of the drying air.

The air knife itself can consist of a slit for the air outlet, or of a plurality of nozzles, arranged in parallel, perhaps with slightly varying angles to best cover certain heights and angles of the user's posterior.

In addition to adding air extracts to the air knife, additional air extract ports 1780 can be placed into the toilet or toilet seat. Ducts for the air extracts 1790 are also shown.

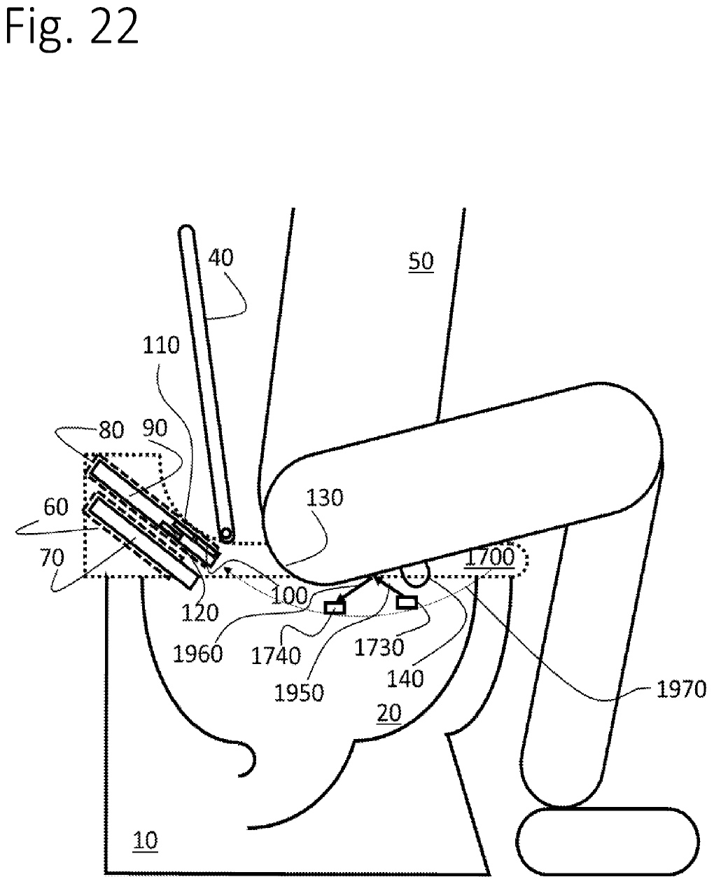

FIG. 22 shows a side view of a toilet device 10 with toilet seat 1700 with a user 50 and an arrangement of a drying mechanism for the user's posterior 130 and front genitals 140. An example trajectory 1950 of air from an air knife bar 1730 is shown. In a preferred embodiment, said air has a relatively low angle towards the user's posterior. Such a relatively low angle can improve sheeting off liquid attached to the user's posterior from the bidet-based cleaning of the user's posterior or genitals. However, care should be taken in the design such as to prevent interfering with male user's genitals during drying. The air path of the droplet laden air 1960 from the user's posterior into the air extract bar 1740 is also shown. A preferred path 1970 of the air knife bar across the toilet seat is to start from a resting position in the toilet seat, then dip downwards as it is swept across the seat and move back up towards the rear of the toilet seat. The air path is to be designed such that the air extract bar collects the droplet-laden drying air as it is reflecting off the user's posterior. For very elaborate designs, it is possible to add a second axis of motion that governs the vertical distance of the air knife bar and air extract bar from the user's posterior. Such a second axis can be driven in a fixed program or guided by sensors, such as optical, capacitive, or air back pressure sensors to judge the proximity of the air knife to the user as all times of operation. One simple means to achieve an arc for the air knife bar and air extract mechanism moving downward and back upward is for example by proper tilting of the rotational axis of the pivot. Another simple means is by using gravity and having the arms of the air knife bar and the air extract bar follow a track close to the pivot point that guides them downward and back upward again.

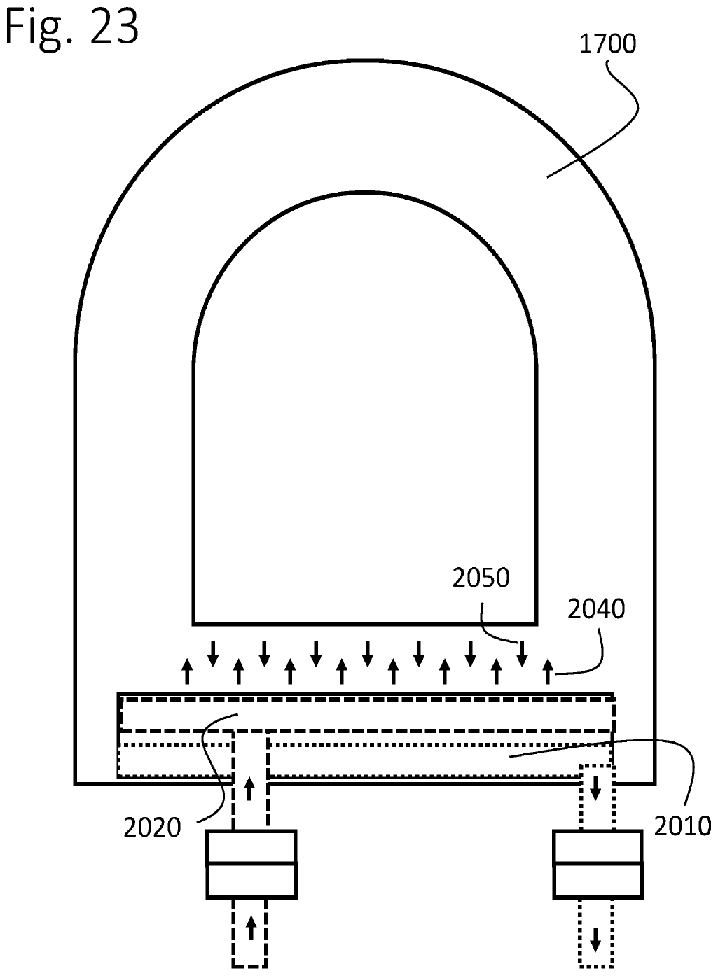

FIG. 23 shows the top view of a toilet seat 1700, containing a vacuum loaded or extract air loaded air curtain across the rear of the toilet seat. Additional forced air 2040 is guided towards the user's lower back or upper posterior while at the same time air is extracted 2050 from this region. This is enabled by an extract loaded air supply with negative pressure 2010 in the rear of the toilet seat, combined with a duct and supply for drying air 2020. Such an air curtain can serve to prevent droplet laden air from the drying process to be expelled at the rear of the toilet seat during the drying process. Practicality determines whether such a two-directional air curtain is required or whether merely additional air or additional air extraction are beneficial for preventing droplet-laden air from being expelled.

The devices, structures, mechanisms and procedures presented in this disclosure provide a multitude of benefits. Not only do they enable the user to have direct feedback and good control over their cleanliness. They also provide capability for early detection of any health issues related either to bowel movement or more generally to the posteriors or genitals of the person, such as early detection and avoidance of decubitus, of fistulas or hemorrhoids, or even of scrotum infections or necrotic skin tissue in any posterior position of the body. Other instances such as the onset of menstruation, the formation of fungal infections and much more can be determined. Also, users can utilize the camera functions to help guide them while urinating on urine analysis strips or to help especially female users with self-implementation of catheters, which is a topic of daily challenge, particularly for female paraplegic users of the toilet. In addition, when combined with diet diaries, sources for food allergies, diarrhea and constipation can all be detected and correlated with rashes or other skin reactions, as well as with specific bowel movement issues earlier and more reliably. Sharing such images and data including their history has high value for the medical providers and may turn out to cut health care costs significantly. This holds not only for mobility or sensory impaired people but also for non-impaired people. Several features presented here require integration and installation of a completely new toilet device. However, it is also envisioned that all or most features can be implemented as part of an add-on kit to an existing toilet device.

What is claimed is:

1. A toilet device, comprising:
A toilet bowl with bidet function providing a cleaning fluid or water jet for cleaning a user's posterior or genital region, said fluid or water jet being provided through a bidet tube which is actuated and controllable along a first direction of motion into and outward a toilet bowl, a second direction of motion of actuation and control for said bidet tube delivering said fluid or water jet with a preference of said second direction of motion being a rotation around its axis such as to allow for a sideways sweeping of said cleaning fluid or water jet,
a camera, sensitive to visible light, mounted on a camera mount body which allows for the camera to be retracted in an idle position and engaged for operation in a plurality of engaged positions,
an automatable cleaning and drying system for said camera which is engaged during the motion of the camera mount body between idle and engaged positions,
an illumination source to bring visible light onto the user's posterior or genital region to allow capturing a camera image,
a viewing monitor allowing a user to observe and capture images or video from said camera of a bidet cleaning process as well as allowing a user to observe and capture images or video of a user's posterior or genital regions, said images to be stored on a controller with data or image storage capability,
a means for the user to control the bidet function to clean or rinse their posterior or genital region by way of either using said viewing monitor through a touchscreen function, or by using a joystick to control cleaning jet position and direction of motion, or to control jet condition such as strength or pulsation, as well as to control camera observation region
and a controller to control all actuation, sensing, display, storage, computing and optional data analysis.

2. The toilet device in claim 1, wherein the user is provided an indicator such as crosshairs projected onto the monitor image of the user's posterior or genital region, wherein said crosshairs indicate where on the user's posterior or genital region said cleaning fluid or water jet is directed to and wherein said information for the crosshairs location is achieved by continuously tracking the status of the actuators such as the drive motors for said directions of motion of bidet tube and camera mount body, by the tracking of the cleaning fluid or water jet and by geometric considerations all being captured via an algorithm that provides said continuously updated crosshair location.

3. The toilet device in claim 1, wherein the user is provided an indicator such as a laser or other suitably collimated narrow point light source captured in the monitor image, wherein said laser point emanates from a laser pointing device which emanates in parallel in direct proximity to said cleaning fluid or water jet or wherein said laser pointing devices shines a laser directly through and concentric with said cleaning fluid or water jet and wherein said laser point on said viewing monitor indicates to the user the location where said cleaning fluid or water jet is directed towards on the user's posterior or genital region.

4. The toilet device in claim 1, wherein said second direction of motion is a rotation and is accomplished by rotating the bidet tube housing.

5. The toilet device in claim 1, additionally comprising an infrared or thermal imaging camera, mounted suitably parallel to said camera and able to capture, store and display infrared or thermal images on said viewing monitor.

6. The toilet device in claim 1, further comprising a software capable of analyzing and correlating or aligning images from said visible light camera and infrared or thermal imaging camera for the benefit of distinguishing certain features or anomalies of a user's posterior or genital region with infrared or thermal signatures from such features or anomalies without infrared or thermal signatures.

7. The toilet device in claim 1, further comprising illumination of different visible wavelength for highlighting certain features and anomalies of a user's posterior and a software capable of correlating or aligning images captured using different illumination conditions such as different wavelength.

8. The toilet device in claim 1, further comprising software which allows correlating, aligning, tracking and comparison of images of a user's posterior or genital region over a period of time, wherein said software has capability to determine and alert a use of changes, addition or subtraction of certain features or anomalies the software has detected on images of a user's posterior or genital region.

9. The toilet device in claim 1, further comprising a door or flap covering said camera mount body while in retracted idle position wherein said door or flap is opened by the actuation mechanism of said camera.

10. The toilet device in claim 9, wherein said door also comprises a line through which fluid or drying air can be delivered to the tip of said camera mount body.

11. The toilet device in claim 1, wherein said camera is protected by an at least partially transparent cover which is easily removable and which is sealed to said camera mount by means of an O-Ring.

12. A toilet device with toilet bowl and a toilet seat with actuatable segments, with a motorized toilet seat cover that doubles as a back rest, wherein said motorized seat components are able to bring a user from an L-shaped seating position between user's torso and upper legs into a V-shaped position and wherein said motorized seat components are capable to bring the user into a squeezed position or into a rocking motion by correlated motion of backrest and actuated seat segments.

13. The toilet device in claim 12, further comprising a foot stool that can be actuated to support lifting a user's legs to form said V-shaped position.

14. The toilet device in claim 12, further comprising an extendable and collapsing front skirt as splash guard.

15. The toilet device in claim 12, further comprising an inflatable back support and a pressure sensor with cut-off or limit switch to prevent a user from being exposed to excessive squeezing forces when in a V-shaped position.

16. The toilet device in claim 12, further comprising an actuation in said toilet seat that supports pulling apart a user's posterior or genital regions for improved bowel movement.

17. The toilet device in claim 1, further comprising a toilet seat with actuatable segments, with a motorized toilet seat cover that doubles as a back rest, wherein said motorized seat components are able to bring a user from an L-shaped seating position between user's torso and upper legs into a V-shaped position and wherein said motorized seat components are capable to bring the user into a squeezed position or into a rocking motion by correlated motion of backrest and actuated seat segments.

18. The toilet device in claim 17, further comprising an actuation in said toilet seat that supports pulling apart a user's posterior or genital regions to enable improved enema function, cleaning and drying of said user's posterior or genital region.

19. A toilet device with integrated bidet functions for cleaning a user's posterior or genital functions and with an actuatable drying function, wherein said actuatable drying function consists of an arm with a drying air knife, comprising an actuated slit nozzle or a plurality of nozzles that may be directed towards a user and sweep, at a distance, past a user's genital or posterior region, said drying nozzle having a resting position, said resting position being equipped with a cleaning and drying function for said drying air knife which can be activated prior to or after each drying sweep of the air knife.

20. The toilet device in claim 19, further comprising an air extract bar which is moved in conjunction with said drying air knife and which serves to capture droplets sheared off of the user's skin surface during the operation of said drying air knife.
